(19) United States
(12) Patent Application Publication
(10) Pub. No.: US 2022/0049058 A1
(43) Pub. Date: Feb. 17, 2022

(54) POLYMERIC MATERIAL AND PRODUCTION METHOD THEREFOR, AND POLYMERIC COMPOSITION

(71) Applicant: Osaka University, Suita-shi (JP)

(72) Inventors: Akira Harada, Suita-shi (JP); Hiroyasu Yamaguchi, Suita-shi (JP); Yoshinori Takashima, Suita-shi (JP); Motofumi Osaki, Suita-shi (JP); Junsu Park, Suita-shi (JP)

(73) Assignee: Osaka University, Suita-shi (JP)

(21) Appl. No.: 17/299,429

(22) PCT Filed: Dec. 5, 2019
(86) PCT No.: PCT/JP2019/047720

§ 371 Date: Jun. 3, 2021

(30) Foreign Application Priority Data
Dec. 5, 2018 (JP) 2018-228568

(51) Int. Cl. C08G 83/00

(52) U.S. Cl. CPC C08G 83/008

(57) ABSTRACT

Provided are a macromolecular material excellent in mechanical strength and a production method therefor. A macromolecular material of the present invention has a structure crosslinked through host-guest interaction, and is obtained by a method including: a step of preparing a mixture of a host-group-containing macromolecular compound swollen or dissolved in a solvent and a guest-group-containing macromolecular compound swollen or dissolved in a solvent; and a step of mechanically kneading the mixture. As another aspect, a macromolecular material of the present invention is obtained by a method including: a step of swelling or dissolving a both host-group- and guest-group-containing macromolecular compound in a solvent; and a step of mechanically kneading the swollen or dissolved macromolecular compound.

### TECHNICAL FIELD

The present invention relates to a macromolecular material and a production method therefor, and a macromolecular composition.

### BACKGROUND ART

In recent years, development of supramolecular materials provided with various functionalities has actively taken place by taking advantage of non-covalent interactions represented by host-guest interaction. For example, Patent Literature 1 discloses a macromolecular material using host-guest interaction. Such a macromolecular material using host-guest interaction has excellent properties, such as excellent mechanical properties, that have not been realized by hitherto known art, and thus is attracting attention as a new material from various fields.

### CITATION LIST

### Patent Literature

PTL 1: WO2015/030079

### SUMMARY OF INVENTION

### Technical Problem

A recent requirement is to impart various functionalities to macromolecular materials themselves. For example, there is a great need to develop a macromolecular material with further improved mechanical properties. In this regard, hitherto known macromolecular materials using host-guest interaction have certain mechanical strength but have yet to reach a further enhanced level required in recent years, and thus, further improvement has been demanded.

The present invention has been made in consideration of the above. An objective of the present invention is to provide a macromolecular material excellent in mechanical strength and a production method therefor, and a macromolecular composition.

### Solution to Problem

The present inventors conducted extensive research to achieve the above objective, found that the above objective can be achieved by adopting a production method that includes a specific step, and completed the present invention.

Specifically, the present invention includes the subject matter described in the following items, for example.

### Item 1

A macromolecular material having a structure crosslinked through host-guest interaction, the macromolecular material being obtained by a method including:

a step of preparing a mixture that contains a host-group-containing macromolecular compound and a guest-group-containing macromolecular compound; and

a step of mechanically kneading the mixture.

### Item 2

The macromolecular material according to Item 1, wherein the host-group-containing macromolecular compound and the guest-group-containing macromolecular compound contained in the mixture are each swollen or dissolved in a solvent.

### Item 3

A macromolecular material having a structure crosslinked through host-guest interaction, the macromolecular material being obtained by a method including a step of mechanically kneading a raw material that contains a both host-group- and guest-group-containing macromolecular compound.

### Item 4

The macromolecular material according to Item 3, wherein the both host-group- and guest-group-containing macromolecular compound contained in the raw material is swollen or dissolved in a solvent.

### Item 5

A production method of a macromolecular material having a structure crosslinked through host-guest interaction, the production method including:

a step of preparing a mixture that contains a host-group-containing macromolecular compound and a guest-group-containing macromolecular compound; and

a step of mechanically kneading the mixture.

### Item 6

The production method according to Item 5, wherein the host-group-containing macromolecular compound and the guest-group-containing macromolecular compound contained in the mixture are each swollen or dissolved in a solvent.

### Item 7

A production method of a macromolecular material having a structure crosslinked through host-guest interaction, the production method including

a step of mechanically kneading a raw material that contains a both host-group- and guest-group-containing macromolecular compound.

### Item 8

A production method according to Item 7, wherein the both host-group- and guest-group-containing macromolecular compound contained in the raw material is swollen or dissolved in a solvent.

### Item 9

A macromolecular composition that contains a host-group-containing macromolecular compound swollen or dissolved in a solvent and a guest-group-containing macromolecular compound swollen or dissolved in a solvent.

### Item 10

The macromolecular composition according to Item 9, wherein the solvent includes an organic solvent.

### Item 11

A host-group-containing macromolecular compound configured to be used so as to be mechanically kneaded with a guest-group-containing macromolecular compound,

the host-group-containing macromolecular compound being configured to undergo host-guest interaction with the guest-group-containing macromolecular compound.

### Item 12

A guest-group-containing macromolecular compound configured to be used so as to be mechanically kneaded with a host-group-containing macromolecular compound,

the guest-group-containing macromolecular compound being configured to undergo host-guest interaction with the host-group-containing macromolecular compound.

### Item A

A host-group-containing macromolecular compound configured to be used so as to form, by a cast method, a coat that contains the host-group-containing macromolecular compound and a guest-group-containing macromolecular compound,

the host-group-containing macromolecular compound being configured to undergo host-guest interaction with the guest-group-containing macromolecular compound.

### Item B

A guest-group-containing macromolecular compound configured to be used so as to form, by a cast method, a coat that contains the guest-group-containing macromolecular compound and a host-group-containing macromolecular compound,

the guest-group-containing macromolecular compound being configured to undergo host-guest interaction with the host-group-containing macromolecular compound.

### Advantageous Effects of Invention

The macromolecular material according to the present invention has excellent mechanical strength.

According to the production method of the macromolecular material of the present invention, a macromolecular material having excellent mechanical strength can be obtained.

The macromolecular composition according to the present invention is suitable as a raw material for producing the macromolecular material.

### BRIEF DESCRIPTION OF DRAWINGS

FIG. 1 (a) shows a polymerization reaction scheme performed in Synthesis Example 2-1, and (b) shows a polymerization reaction scheme performed in Synthesis Example 3-1.

FIG. 2 shows results of tensile tests performed on macromolecular materials obtained in Example 1-1, Example 1-2, Reference Example 1, and Comparative Example 2, wherein (a-1), (b-1), and (c-1) show stress-strain curves, and (a-2), (b-2), and (c-2) show calculation results of fracture energy.

FIG. 3 shows measurement results of Young's modulus calculated from the stress-strain curves obtained in the tensile tests performed on the macromolecular materials obtained in Example 1-1, Example 1-2, Reference Example 1, and Comparative Example 2.

FIG. 4 shows maximum stress calculated from each of the stress-strain curves obtained in the tensile tests performed on the macromolecular materials obtained in Example 1-1, Example 1-2, Reference Example 1, and Comparative Example 2.

FIG. 5 shows elongation at break calculated from each of the stress-strain curves obtained in the tensile tests performed on the macromolecular materials obtained in Example 1-1, Example 1-2, Reference Example 1, and Comparative Example 2.

FIG. 6 shows fracture energy calculated from each of the stress-strain curves obtained in the tensile tests performed on the macromolecular materials obtained in Example 1-1, Example 1-2, Reference Example 1, and Comparative Example 2.

FIG. 7 shows results of recycling property of the macromolecular materials obtained in Example 1-2.

FIG. 8 shows results of charging and discharging of batteries in which the macromolecular materials obtained in Example 2-1 were used as binders.

FIG. 9 shows calculation results of fracture energy of the macromolecular materials obtained in Example 1-2, Example 2-2, and Comparative Example 2.

FIG. 10 shows calculation results of fracture energy of the macromolecular materials obtained in Example 1-1, Example 2-1, and Comparative Example 2.

### DESCRIPTION OF EMBODIMENTS

The following describes embodiments of the present invention in detail. In the present specification, the terms “contain” and “include” encompass the concepts of “contain”, “include”, “consist essentially of”, and “consist of”.

1. Macromolecular Material

A macromolecular material of the present invention has a structure crosslinked through host-guest interaction. Hereinafter, the macromolecular material of the present invention will be simply referred to as a “macromolecular material”. The macromolecular material can include, for example, a first form and a second form described below.

A first form of the macromolecular material is obtained by a method including a step of preparing a mixture that contains a host-group-containing macromolecular compound and a guest-group-containing macromolecular compound, and a step of mechanically kneading the mixture. Preferably, the macromolecular material of the first form is obtained by a method including a step of preparing a mixture that contains a host-group-containing macromolecular compound swollen or dissolved in a solvent and a guest-group-containing macromolecular compound swollen or dissolved in a solvent, and a step of mechanically kneading the mixture.

The second form of the macromolecular material is obtained by a method including a step of mechanically kneading a raw material that contains a both host-group- and guest-group-containing macromolecular compound. Preferably, the macromolecular material of the second form is obtained by a method including a step of preparing a raw material that contains a both host-group- and guest-group-containing macromolecular compound swollen or dissolved in a solvent, and a step of mechanically kneading the swollen or dissolved macromolecular compound.

First, the host-group-containing macromolecular compound and the guest-group-containing macromolecular compound of the first form of the macromolecular material, and the host-group- and guest-group-containing macromolecular compound of the second form of the macromolecular material are described.

(Host-Group-Containing Macromolecular Compound)

The type of the host-group-containing macromolecular compound is not particularly limited, and, for example, a wide range of known host-group-containing macromolecular compounds can be adopted. Examples of the host-group-containing macromolecular compound can include a macromolecular compound having a host group at a side chain thereof. The “host-group-containing macromolecular compound” can mean that, for example, a host group is chemically bonded to the main chain or side chain of the macromolecular compound.

The host-group-containing macromolecular compound can be obtained by, for example, polymerizing a monomer including a host-group-containing polymerizable monomer. This monomer may include a third polymerizable monomer described later, in addition to the host-group-containing polymerizable monomer. The third polymerizable monomer is a monomer other than the host-group-containing polymerizable monomer and a guest-group-containing polymerizable monomer.

That is, the host-group-containing macromolecular compound can include, as structural units, a host-group-containing polymerizable monomer unit and a third polymerizable monomer unit. The third polymerizable monomer unit is a monomer unit other than the host-group-containing polymerizable monomer unit and the guest-group-containing polymerizable monomer unit.

The type of the host group is not particularly limited, and a wide range of known host groups can be adopted. Examples of the host group can include a monovalent group formed by removing one hydrogen atom or hydroxy group from a cyclodextrin or a cyclodextrin derivative. It should be noted that the cyclodextrin as used in the present specification means at least one member selected from the group consisting of α-cyclodextrin, β-cyclodextrin, and γ-cyclodextrin. Therefore, the cyclodextrin derivative is at least one member selected from the group consisting of α-cyclodextrin derivatives, β-cyclodextrin derivatives, and γ-cyclodextrin derivatives.

The cyclodextrin derivative is not particularly limited, and can have a structure in which at least one hydroxy group of a cyclodextrin is substituted with at least one group selected from the group consisting of a hydrocarbon group, an acyl group, and —CONHR (where R represents a methyl group or an ethyl group), for example. With this structure, for example, the host-group-containing polymerizable monomer can exhibit high affinity for both hydrophilic polymerizable monomers and hydrophobic polymerizable monomers, and thus, can copolymerize with various monomers. In the present specification, “at least one group selected from the group consisting of a hydrocarbon group, an acyl group, and —CONHR (where R represents a methyl group or an ethyl group)” may be referred to as a “hydrocarbon group and the like”, for convenience.

When the total number of hydroxy groups in a single molecule of a cyclodextrin is N, N of α-cyclodextrin is 18, N of β-cyclodextrin is 21, and N of γ-cyclodextrin is 24.

If the host group is a monovalent group formed by removing one “hydroxy group” from a cyclodextrin derivative, hydrogen atoms of a maximum number of N−1 hydroxy groups can be substituted with the hydrocarbon group and the like, per molecule of the cyclodextrin derivative. Meanwhile, when the host group is a monovalent group formed by removing one “hydrogen atom” from a cyclodextrin derivative, hydrogen atoms of a maximum number of N hydroxy groups can be substituted with the hydrocarbon group and the like, per molecule of the cyclodextrin derivative.

The host group preferably has a structure in which the hydrogen atoms of 70% or more of the total number of hydroxy groups present per molecule of the cyclodextrin derivative are substituted with the hydrocarbon group and the like. In this case, the host-group-containing polymerizable monomer can exhibit higher affinity for hydrophobic polymerizable monomers. The host group preferably has a structure in which the hydrogen atoms of 80% or more of the total number of hydroxy groups present per molecule of the cyclodextrin derivative are substituted with the hydrocarbon group and the like, and particularly preferably has a structure in which the hydrogen atoms of 90% or more of the total number of hydroxy groups present per molecule of the cyclodextrin derivative are substituted with the hydrocarbon group and the like.

The host group preferably has a structure in which the hydrogen atoms of 13 or more hydroxy groups of the total number of hydroxy groups present per molecule of the α-cyclodextrin derivative are substituted with the hydrocarbon group and the like. In this case, the host-group-containing polymerizable monomer can exhibit higher affinity for hydrophobic polymerizable monomers. The host group preferably has a structure in which the hydrogen atoms of 15 or more hydroxy groups of the total number of hydroxy groups present per molecule of the α-cyclodextrin derivative are substituted with the hydrocarbon group and the like, and particularly preferably has a structure in which the hydrogen atoms of 17 hydroxy groups of the total number of hydroxy groups present per molecule of the α-cyclodextrin derivative are substituted with the hydrocarbon group and the like.

The host group preferably has a structure in which the hydrogen atoms of 13 or more hydroxy groups of the total number of hydroxy groups present per molecule of the β-cyclodextrin derivative are substituted with the hydrocarbon group and the like. In this case, the host-group-containing polymerizable monomer can exhibit higher affinity for hydrophobic polymerizable monomers. The host group more preferably has a structure in which the hydrogen atoms of 17 or more hydroxy groups of the total number of hydroxy groups present per molecule of the β-cyclodextrin derivative are substituted with the hydrocarbon group and the like, and particularly preferably has a structure in which the hydrogen atoms of 19 or more hydroxy groups of the total number of hydroxy groups present per molecule of the β-cyclodextrin derivative are substituted with the hydrocarbon group and the like.

The host group preferably has a structure in which the hydrogen atoms of 17 or more hydroxy groups of the total number of hydroxy groups present per molecule of the γ-cyclodextrin derivative are substituted with the hydrocarbon group and the like. In this case, the host-group-containing polymerizable monomer can exhibit higher affinity for hydrophobic polymerizable monomers. The host group more preferably has a structure in which the hydrogen atoms of 19 or more hydroxy groups of the total number of hydroxy groups present per molecule of the γ-cyclodextrin derivative are substituted with the hydrocarbon group and the like, and particularly preferably has a structure in which the hydrogen atoms of 22 or more hydroxy groups of the total number of hydroxy groups present per molecule of the γ-cyclodextrin derivative are substituted with the hydrocarbon group and the like.

The type of the hydrocarbon group is not particularly limited. Examples of the hydrocarbon group can include an alkyl group, an alkenyl group, and an alkynyl group.

The number of carbon atoms of the hydrocarbon group is not particularly limited. The number of carbon atoms of the hydrocarbon group is preferably 1 to 4 from the viewpoints that such a host-group-containing polymerizable monomer exhibits higher affinity for both hydrophilic polymerizable monomers and hydrophobic polymerizable monomers, and that host-guest interaction easily occurs.

Specific examples of the hydrocarbon group having 1 to 4 carbon atoms can include a methyl group, an ethyl group, a propyl group, and a butyl group. When the hydrocarbon group is a propyl group or a butyl group, the hydrocarbon group may be linear or branched.

The hydrocarbon group may include a substituent as long as the effects of the present invention are not impaired. Examples of the “substituent” as used in the present specification can include an alkyl group having 1 to 20 carbon atoms, an alkenyl group having 2 to 20 carbon atoms, an alkynyl group having 2 to 20 carbon atoms, a halogen atom, a carboxyl group, a carbonyl group, a sulfonyl group, a sulfone group, and a cyano group.

Examples of the acyl group include an acetyl group, a propionyl, and a formyl group. The acyl group may further include a substituent. The acyl group is preferably an acetyl group from the viewpoints that the host-group-containing polymerizable monomer exhibits higher affinity for both hydrophilic polymerizable monomers and hydrophobic polymerizable monomers, that host-guest interaction easily occurs, and additionally, that a macromolecular material excellent in toughness and strength can be easily obtained.

—CONHR (where R represents a methyl group or an ethyl group) is a methyl carbamate group or an ethyl carbamate group. —CONHR is preferably an ethyl carbamate group from the viewpoints that the host-group-containing polymerizable monomer exhibits higher affinity for both hydrophilic polymerizable monomers and hydrophobic polymerizable monomers, and that host-guest interaction easily occurs.

The type of the host-group-containing polymerizable monomer is not particularly limited, and, for example, a wide range of known host-group-containing polymerizable monomers can be adopted. For example, the type of the host-group-containing polymerizable monomer is not particularly limited as long as the host-group-containing polymerizable monomer has a host group and a polymerizable functional group. Specific examples of the polymerizable functional group include —OH, —SH, —NH₂, —COOH, —SO₃H, —PO₄H, an isocyanate group, and an epoxy group (glycidyl group), in addition to an alkenyl group, a vinyl group, and the like. In a cyclodextrin or a cyclodextrin derivative, these polymerizable functional groups can be introduced into the cyclodextrin derivative by substituting the hydrogen atom of at least one hydroxy group of the cyclodextrin. Accordingly, a host-group-containing polymerizable monomer having a polymerizable functional group is formed.

Examples of the host-group-containing polymerizable monomer can include a compound in which a host group is bonded (e.g., through covalent bond) to a vinyl compound having a radically polymerizable functional group.

Examples of the radically polymerizable functional group can include a group having a carbon-carbon double bond. Specifically, examples of the radically polymerizable functional group include an acryloyl group (CH₂═CH(CO)—), a methacryloyl group (CH₂═CCH₃(CO)—), a styryl group, a vinyl group, and an allyl group. These groups having a carbon-carbon double bond may further include a substituent as long as the radically polymerizable properties are not impaired.

Specific examples of the host-group-containing polymerizable monomer can include polymerizable vinyl monomers to which the host group is bonded. For example, the host-group-containing vinyl monomer is a compound represented by the following general formula (h1)

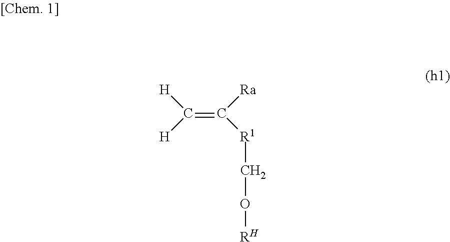

(in formula (h1), Ra represents a hydrogen atom or a methyl group, R^{H} represents the host group, and R¹ represents a divalent group formed by removing one hydrogen atom from a monovalent group selected from the group consisting of a hydroxyl group, a thiol group, an alkoxy group optionally having one or more substituents, a thioalkoxy group optionally having one or more substituents, an alkyl group optionally having one or more substituents, an amino group optionally having one substituent, an amide group optionally having one substituent, an aldehyde group, and a carboxyl group).

Alternatively, an example of the host-group-containing polymerizable monomer is a compound represented by the following general formula (h2)

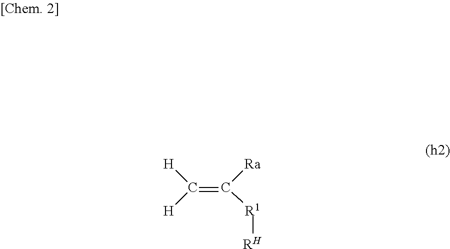

(in formula (h2), Ra, R^{H}, and R¹ are respectively synonymous with Ra, R^{H}, and R¹ of formula (h1)).

Further, the host-group-containing polymerizable monomer is a compound represented by the following general formula (h3)

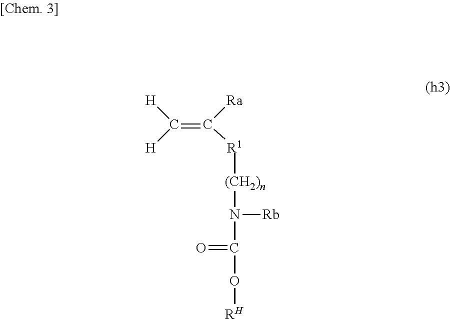

(in formula (h3), Ra, R^{H}, and R¹ are respectively synonymous with Ra, R^{H}, and R¹ of formula (h1). n is an integer of 1 to 20, preferably 1 to 10, more preferably 1 to 5. Rb represents hydrogen or an alkyl group having 1 to 20 carbon atoms (preferably, an alkyl group having 1 to 10 carbon atoms, and more preferably an alkyl group having 1 to 6 carbon atoms)).

The host group R^{H} of the host-group-containing polymerizable monomer represented by formulas (h1), (h2), and (h3) is an example of a monovalent group formed by removing one hydroxy group from a cyclodextrin derivative.

The host-group-containing polymerizable monomer may be a single compound among those represented by formula (h1), formula (h2), and formula (h3), or may include two or more of those represented by formula (h1), formula (h2), and formula (h3). In this case, Ra of formula (h1), formula (h2), and formula (h3) may be identical to or different from each other. Similarly, R^{H} of formula (h1), formula (h2), and formula (h3) may be identical to or different from each other, and R¹ of formula (h1), formula (h2), and formula (h3) may be identical to or different from each other.

The substituents defined in formula (h1) to (h3) are not particularly limited. Examples of such substituents can include an alkyl group having 1 to 20 carbon atoms, an alkenyl group having 2 to 20 carbon atoms, an alkynyl group having 2 to 20 carbon atoms, a halogen atom, a carboxyl group, a carbonyl group, a sulfonyl group, a sulfone group, and a cyano group.

When R¹ in (h1) to (h3) is a divalent group formed by removing one hydrogen atom from an amino group optionally having one substituent, the nitrogen atom of the amino group can bond to the carbon atom of the C═C double bond.

When R¹ in (h1) to (h3) is a divalent group formed by removing one hydrogen atom from an amide group optionally having one substituent, the carbon atom of the amide group can bond to the carbon atom of the C═C double bond.

When R¹ in (h1) to (h3) is a divalent group formed by removing one hydrogen atom from an aldehyde group, the carbon atom of the aldehyde group can bond to the carbon atom of the C═C double bond.

When R¹ in (h1) to (h3) is a divalent group formed by removing one hydrogen atom from a carboxyl group, the carbon atom of the carboxyl group can bond to the carbon atom of the C═C double bond.

The host-group-containing polymerizable monomer represented by (h1) to (h3) is preferably a (meth)acrylic acid ester derivative (i.e., R¹ is —COO—), or a (meth)acrylamide derivative (i.e., R¹ is —CONH— or —CONR—, and R is synonymous with the substituent described above), for example. In this case, polymerization reaction easily proceeds, and the resultant macromolecular material can exhibit higher toughness and strength. In the present specification, (meth)acrylic refers to either acrylic or methacrylic.

R in —CONR— is preferably an alkyl group having 1 to 20 carbon atoms, more preferably an alkyl group having 1 to 10 carbon atoms, and particularly preferably an alkyl group having 1 to 6 carbon atoms, for example.

Specific examples of the host-group-containing polymerizable monomer represented by formula (h1) can include the following compounds (h1-1) to (h1-6).

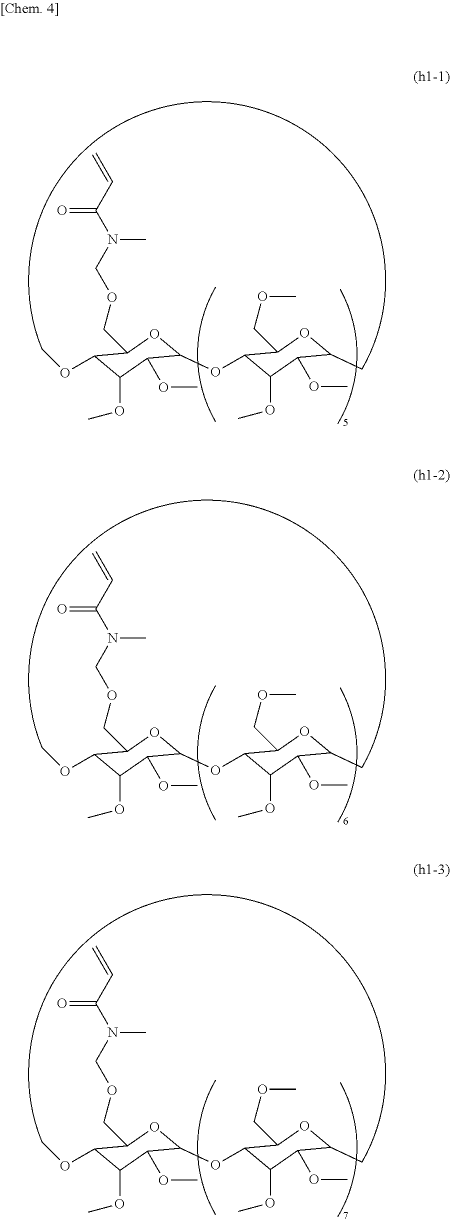

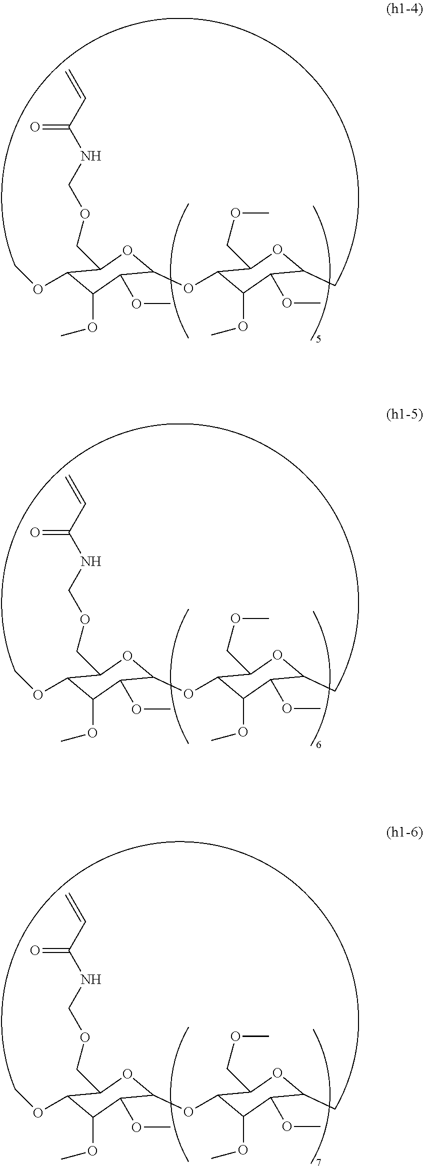

The compounds represented by formulas (h1-1), (h1-2), and (h1-3) are formed such that R¹ in formula (h1) is —CONR— (R=methyl group), and such that (h1-1), (h1-2), and (h1-3) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups of the cyclodextrin derivative are substituted with a methyl group. In the compounds represented by (h1-1), (h1-2), and (h1-3), the nitrogen atom of the amide moiety of each compound can be substituted with methyl through the same reaction as the methyl substitution on the hydrogen atom of the hydroxy groups in the cyclodextrin derivative described later. That is, the compounds represented by formulas (h1-1), (h1-2), and (h1-3) have an advantage that methylation of the cyclodextrin moiety and methylation of the amide moiety can be performed in a single step reaction, and thus, it is easy to obtain the compounds represented by formulas (h1-1), (h1-2), and (h1-3). The same applies to the formulas (h2-1), (h2-2), and (h2-3) described later.

The compounds represented by formulas (h1-4), (h1-5), and (h1-6) are formed such that R¹ in formula (h1) is —CONH—, and such that (h1-4), (h1-5), and (h1-6) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups in the cyclodextrin derivative are substituted with a methyl group.

Specific examples of the host-group-containing polymerizable monomer represented by formula (h1) can include the following compounds (h1-7) to (h1-9).

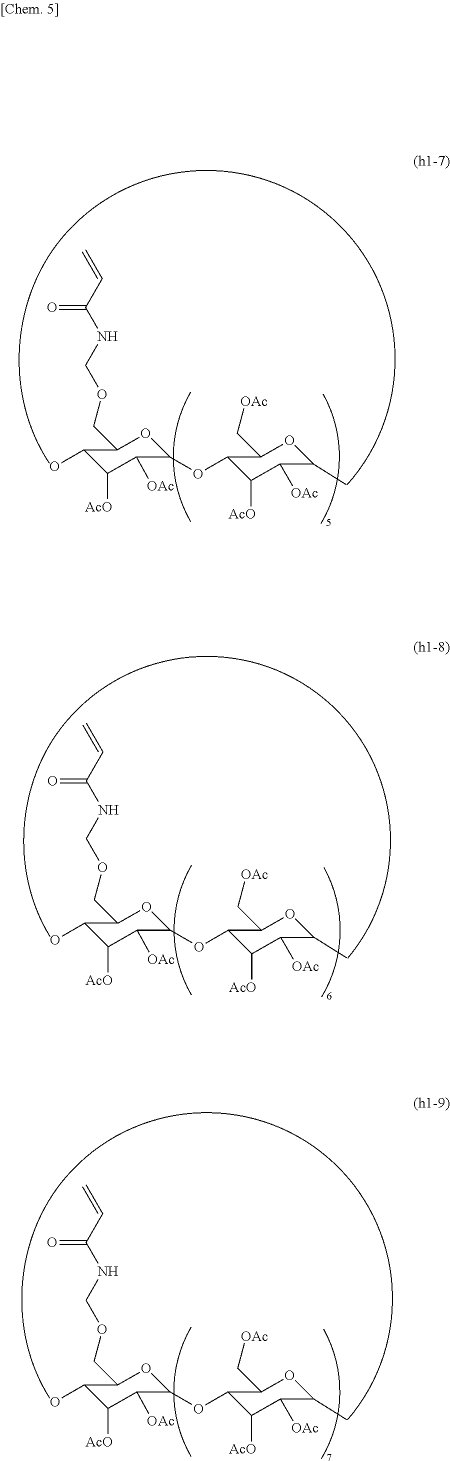

The compounds represented by formulas (h1-7), (h1-8), and (h1-9) are formed such that R¹ in formula (h1) is —CONH—, and such that (h1-7), (h1-8), and (h1-9) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups in the cyclodextrin derivative are substituted with an acetyl group (indicated as “Ac” in each formula).

Specific examples of the host-group-containing polymerizable monomer represented by formula (h1) can include the following compound represented by formula (h1-10).

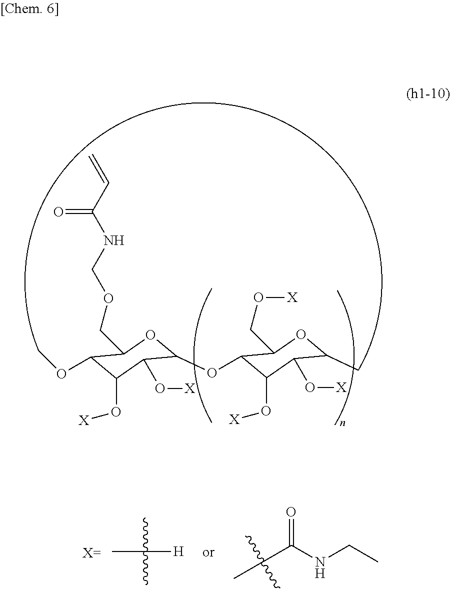

In formula (h1-10), at least one X is a hydrogen atom, and at least one X is —CONHC₂H₅ (ethyl carbamate group). n is 5, 6, or 7.

The compound represented by formula (h1-10) is formed such that R¹ in formula (h1) is —CONH—, and such that (h1-10) has a host group formed by removing one hydroxy group from a cyclodextrin derivative. The hydrogen atoms of N−1 hydroxy groups in the cyclodextrin derivative are substituted with the X.

Specific examples of the host-group-containing polymerizable monomer represented by formula (h2) can include the following compounds (h2-1) to (h2-9).

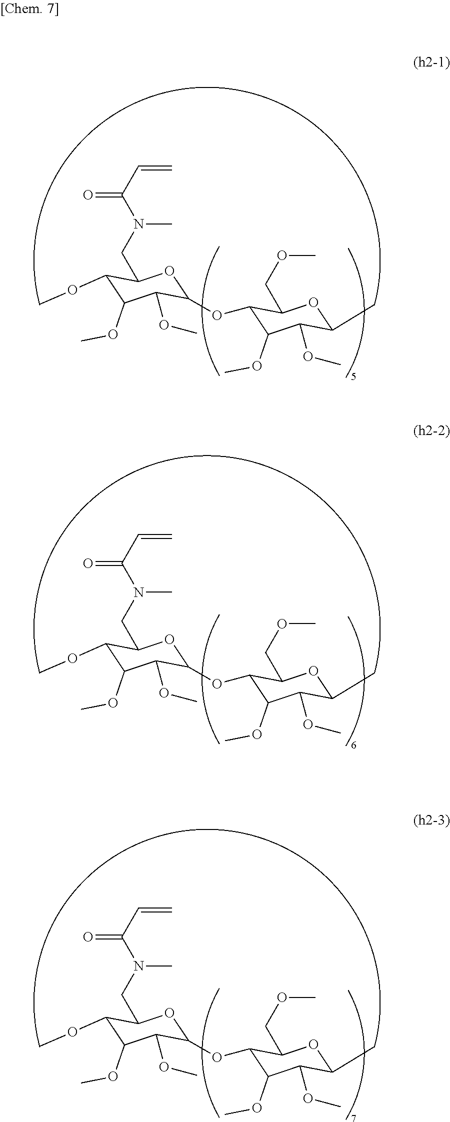

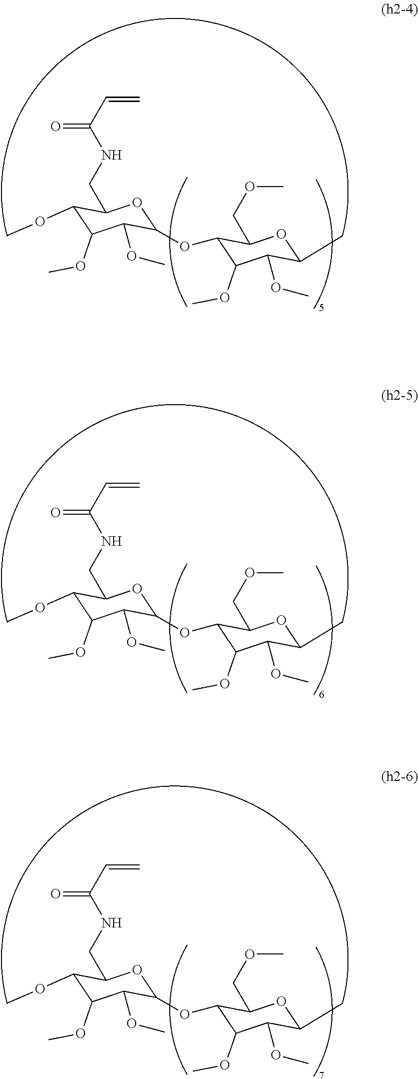

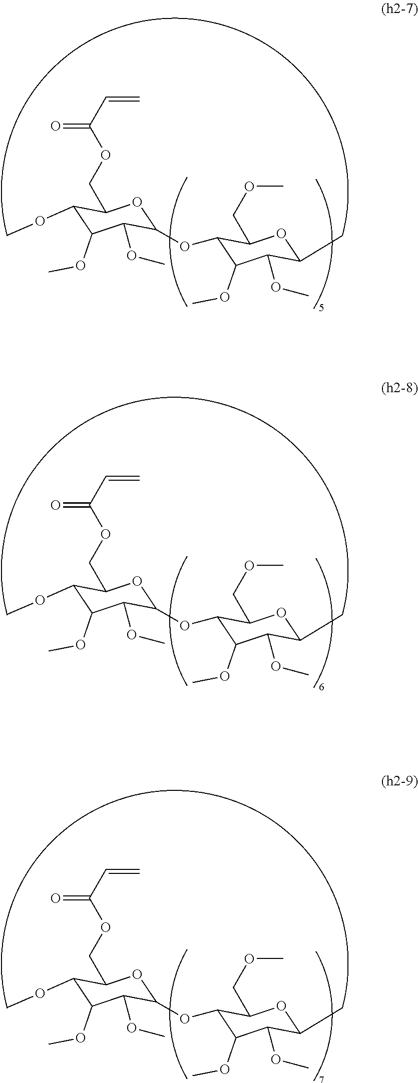

The compounds represented by formulas (h2-1), (h2-2), and (h2-3) are formed such that R¹ in formula (h2) is —CONR— (R=methyl group), and such that (h2-1), (h2-2), and (h2-3) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups in the cyclodextrin derivative are substituted with a methyl group.

The compounds represented by formula (h2-4), (h2-5), and (h2-6) are formed such that R¹ in formula (h2) is —CONH—, and such that (h2-4), (h2-5), and (h2-6) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups in the cyclodextrin derivative are substituted with a methyl group.

The compounds represented by formulas (h2-7), (h2-8), and (h2-9) are formed such that R¹ in formula (h2) is —COO—, and such that (h2-7), (h2-8), and (h2-9) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups in the cyclodextrin derivative are substituted with a methyl group.

Specific examples of the host-group-containing polymerizable monomer represented by formula (h3) can include the following compounds (h3-1) to (h3-6).

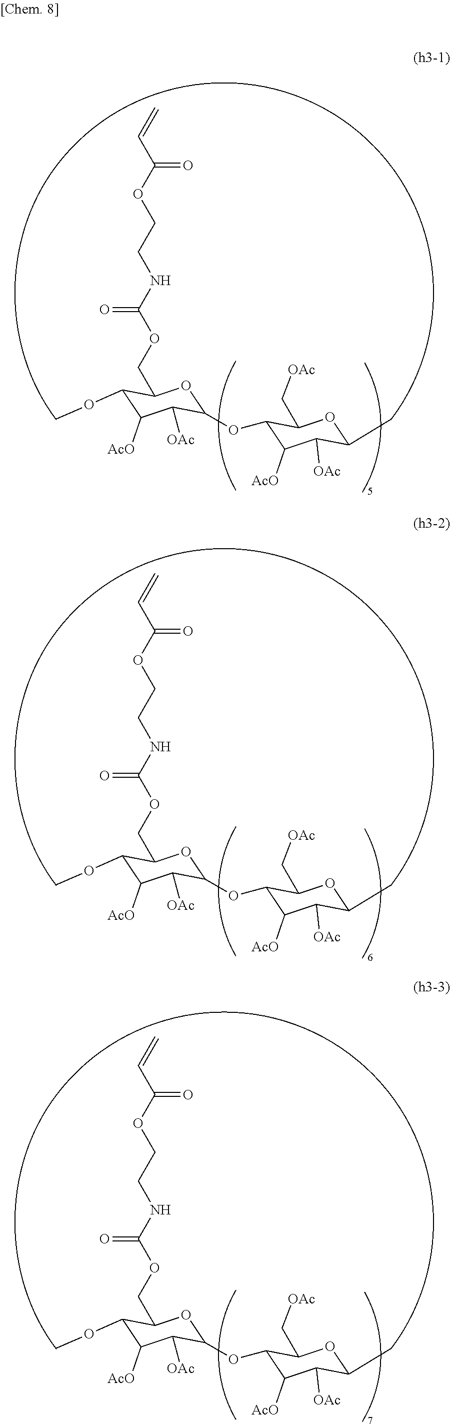

The compounds represented by formulas (h3-1), (h3-2), and (h3-3) are formed such that, in formula (h3), R¹ is —COO—, n is 2, and Rb is a hydrogen atom. The compounds represented by formulas (h3-1), (h3-2), and (h3-3) respectively have a host group formed by removing one hydroxy group from an α-cyclodextrin derivative, a β-cyclodextrin derivative, and a γ-cyclodextrin derivative. In each compound, the hydrogen atoms of N−1 hydroxy groups in the cyclodextrin derivative are substituted with an acetyl group (Ac). In formulas (h3-1), (h3-2), and (h3-3), the hydrogen atom at Rb may be substituted with a methyl group.

The host-group-containing polymerizable monomers represented by (h1-1) to (h1-9), (h2-1) to (h2-9), and (h3-1) to (h3-3) are all acrylic monomers. However, even when these monomers have a structure in which the hydrogen at the meta position is substituted with a methyl group, i.e., are methacrylic monomers, the effects of the present invention are not impaired.

The production method of the host-group-containing polymerizable monomer of the present invention is not particularly limited, and for example, a wide range of known production methods can be adopted.

Examples of the third polymerizable monomer can include various compounds that are copolymerizable with the host-group-containing polymerizable monomer and a guest-group-containing polymerizable monomer described later. Examples of the third polymerizable monomer can include various known polymerizable vinyl monomers.

Specific examples of the polymerizable vinyl monomer can include a compound represented by the following general formula (a1)

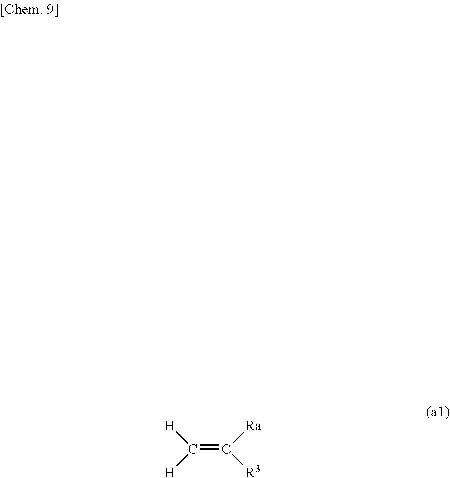

(in formula (a1), Ra represents a hydrogen atom or a methyl group and R³ represents a halogen atom, a hydroxyl group, a thiol group, an amino group optionally having one substituent or a salt thereof, a carboxyl group optionally having one substituent or a salt thereof, an amide group optionally having one or more substituents or a salt thereof, or a phenyl group optionally having one or more substituents).

When R³ in formula (a1) is a carboxyl group having one substituent, examples of the carboxyl group include carboxyl groups whose hydrogen atom is substituted with a hydrocarbon group, a hydroxyalkyl group (e.g., a hydroxymethyl group, a 1-hydroxyethyl group, a 2-hydroxyethyl group), methoxy polyethylene glycol (the number of units of ethylene glycol is 1 to 20, preferably 1 to 10, and particularly preferably 2 to 5), ethoxy polyethylene glycol (the number of units of ethylene glycol is 1 to 20, preferably 1 to 10, and particularly preferably 2 to 5), or the like (i.e., esters).

When R³ in formula (a1) is an amide group having one or more substituents (i.e., a secondary amide or a tertiary amide), examples of the amide group include amide groups formed such that one hydrogen atom or two hydrogen atoms of a primary amide are independently substituted with a hydrocarbon group or a hydroxyalkyl group (e.g., a hydroxymethyl group, a 1-hydroxyethyl group, or a 2-hydroxyethyl group).

R³ in formula (a1) is preferably a carboxyl group having one substituent; an amide group having one or more substituents; an amino group; an amide group; or a carboxyl group. In this case, the structure of the crosslinked polymer that forms the macromolecular material becomes stable, and physical properties of the macromolecular material are more likely to be improved.

In particular, R³ in formula (a1) is preferably a carboxyl group whose hydrogen atom is substituted with an alkyl group having 1 to 10 carbon atoms, or an amide group whose one or more hydrogen atoms are substituted with an alkyl group having 1 to 10 carbons. In this case, the third polymerizable monomer has relatively high hydrophobicity, and thus, copolymerization with the host-group-containing polymerizable monomer easily proceeds. More preferably, the number of carbons of the alkyl group as the substituent is 2 to 8, and particularly preferably 2 to 6. In this case, the toughness and strength of the resultant macromolecular material are more likely to be improved. This alkyl group may be linear or branched.

Specific examples of the monomer represented by formula (a1) include (meth)acrylic acid, allyl amine, maleic anhydride, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, hexyl (meth)acrylate, cyclohexyl (meth)acrylate, N,N-dimethyl (meth)acrylamide, N,N-diethyl acrylamide, N-isopropyl (meth)acrylamide, N-hydroxymethyl (meth)acrylamide, N-hydroxymethyl (meth)acrylate, 2-hydroxyethyl (meth)acrylamide, 2-hydroxyethyl (meth)acrylate, ethoxy-diethylene glycol acrylate, methoxy-triethylene glycol acrylate, methoxy-polyethylene glycol acrylate, and styrene. These monomers may be used singly or in a combination of two or more.

The third polymerizable monomer preferably does not undergo host-guest interaction with the host group of the host-group-containing polymerizable monomer, i.e., has a structure in which a part or the entirety of the third polymerizable monomer does not form a clathrate complex with the host group. Examples of the third polymerizable monomer can include (meth)acrylic acid, allyl amine, maleic anhydride, methyl (meth)acrylate, ethyl (meth)acrylate, (meth)acrylamide, and N,N-diethyl acrylamide.

Specific examples of the third polymerizable monomer can include diene compounds, in addition to the compound represented by general formula (a1). Specific examples of diene compounds can include isoprene and 1,3-butadiene.

The host-group-containing macromolecular compound includes a monomer unit based on the host-group-containing polymerizable monomer and a monomer unit based on the third polymerizable monomer.

In the host-group-containing macromolecular compound, the content of the host-group-containing polymerizable monomer unit is not particularly limited. For example, the content of the host-group-containing polymerizable monomer unit can be 0.01 to 10 mole % with respect to the total number of moles of the monomer units forming the host-group-containing macromolecular compound. In this case, host-guest interaction easily occurs in the macromolecular material, and the mechanical strength thereof is more likely to be improved. With respect to the total number of moles of the monomer units forming the host-group-containing macromolecular compound, the content of the host-group-containing polymerizable monomer unit is preferably 0.05 mole % or more, more preferably 0.1 mole % or more, further preferably 0.5 mole % or more, and particularly preferably 1 mole % or more. With respect to the total number of moles of the monomer units forming the host-group-containing macromolecular compound, the content of the host-group-containing polymerizable monomer unit is preferably 8 mole % or less, more preferably 6 mole % or less, further preferably 5 mole % or less, and particularly preferably 4 mole % or less.

The host-group-containing macromolecular compound may also include a monomer unit other than the host-group-containing polymerizable monomer unit and the third polymerizable monomer unit. When the host-group-containing macromolecular compound includes a monomer unit other than the host-group-containing polymerizable monomer unit and the third polymerizable monomer unit, the content proportion of the monomer unit other than the host-group-containing polymerizable monomer unit and the third polymerizable monomer unit may be 10 mass % or less, preferably 5 mass % or less, more preferably 1 mass % or less, and particularly preferably 0.1 mass % or less, with respect to the total amount of the third polymerizable monomer unit and the host-group-containing polymerizable monomer unit.

The host-group-containing macromolecular compound may be in any form among a random polymer, a block polymer, an alternating copolymer, and the like. In particular, from the viewpoint that host-guest interaction easily occurs, the host-group-containing macromolecular compound is preferably a random polymer.

When the host-group-containing macromolecular compound is produced by polymerizing a monomer including the host-group-containing polymerizable monomer, the polymerization method thereof is not particularly limited. For example, a wide range of known radical polymerization methods and the like can be adopted.

In the macromolecular material, a guest group described later is clathrated in the host group of the host-group-containing macromolecular compound. Accordingly, host-guest interaction occurs and the macromolecular material can have a structure that is crosslinked through the host-guest interaction. The macromolecular material has not only a mode in which the host group and the guest group form a clathrate compound (clathrate complex), but also, for example, a mode in which the guest group penetrates the host group.

As described later, the host-group-containing macromolecular compound can be used so as to be mechanically kneaded with the guest-group-containing macromolecular compound. Through this mechanical kneading, the host-group-containing macromolecular compound and the guest-group-containing macromolecular compound can undergo host-guest interaction, whereby the macromolecular material that contains the host-group-containing macromolecular compound and the guest-group-containing macromolecular compound can be obtained. The obtained macromolecular material is excellent in toughness and mechanical strength. Therefore, the host-group-containing macromolecular compound can be suitably used for the purpose of being mechanically kneaded with the guest-group-containing macromolecular compound.

The host-group-containing macromolecular compound is not only suitable for use in mechanical kneading, but also is suitable as a raw material for forming a coat by a so-called cast method. The cast method is, for example, a method in which an applied film is formed by using a solution of a macromolecular compound and removing a volatile component (e.g., solvent) from the applied film, to form a coat. For example, a coat (macromolecular material) obtained by a cast method using a solution in which the host-group-containing macromolecular compound and the guest-group-containing macromolecular compound are dissolved can have an excellent Young's modulus, and in particular, can have a Young's modulus greater than that of a macromolecular material formed through mechanical kneading. Therefore, from the viewpoint of obtaining a macromolecular material having an excellent Young's modulus, the host-group-containing macromolecular compound can be suitably used as a raw material for forming a coat by a cast method, and in particular, can be suitably used as a raw material for obtaining, by a cast method, a macromolecular material in which host-guest interaction is caused in combination with the guest-group-containing macromolecular compound.

In the first form of the macromolecular material, the host-guest interaction is realized by a polymer chain having the host group and another polymer chain different from said polymer chain. The other polymer chain is the guest-group-containing macromolecular compound described later.

(Guest-Group-Containing Macromolecular Compound)

The type of the guest-group-containing macromolecular compound is not particularly limited, and, for example, a wide range of known guest-group-containing macromolecular compounds can be adopted. Examples of the guest-group-containing macromolecular compound can include a macromolecular compound having a guest group at a side chain thereof. The “guest-group-containing macromolecular compound” can mean that, for example, a guest group is chemically bonded to the main chain or side chain of the macromolecular compound.

The guest-group-containing macromolecular compound can be obtained by, for example, polymerizing a monomer including a guest-group-containing polymerizable monomer. This monomer may include the third polymerizable monomer, in addition to the guest-group-containing polymerizable monomer.

That is, the guest-group-containing macromolecular compound can include, as structural units, a guest-group-containing polymerizable monomer unit and the third polymerizable monomer unit.

The type of the guest group is not limited as long as the guest group undergoes host-guest interaction with the host group, and a wide range of known guest groups can be adopted.

Examples of the guest group include a linear or branched hydrocarbon group having 3 to 30 carbon atoms, a cycloalkyl group, an aryl group, a heteroaryl group, and an organometallic complex. These groups may optionally have one or more substituents. More specific examples of the guest group include a chain-like or cyclic alkyl group having 4 to 18 carbon atoms. The chain-like alkyl group having 4 to 18 carbon atoms may be linear or branched. The cyclic alkyl group may have a structure like a basket. The substituents are the same as those described above, and examples thereof include a halogen atom (e.g., fluorine, chlorine, and bromine), a hydroxy group, a carboxyl group, an ester group, an amide group, and an optionally protected hydroxy group.

Examples of the guest group also include a monovalent group formed by removing one atom (e.g., a hydrogen atom) from a guest molecule, such as at least one member selected from the group consisting of: alcohol derivatives; aryl compounds; carboxylic acid derivatives; amino derivatives; azobenzene derivatives with a cyclic alkyl group or phenyl group; cinnamic acid derivatives; aromatic compounds and alcohol derivatives thereof; amine derivatives; ferrocene derivatives; azobenzenes; naphthalene derivatives; anthracene derivatives; pyrene derivatives; perylene derivatives; clusters composed of carbon atoms, such as fullerenes; and dansyl compounds.

Further specific examples of the guest group can include a t-butyl group, an n-octyl group, an n-dodecyl group, an isobornyl group, an adamantyl group, and groups formed by bonding the above-described substituents to these groups.

Specific examples of the guest-group-containing polymerizable monomer can include polymerizable vinyl monomers to which the guest group is bonded (e.g., through covalent bond).

For example, the guest-group-containing polymerizable monomer is a polymerizable monomer represented by the following general formula (g1)

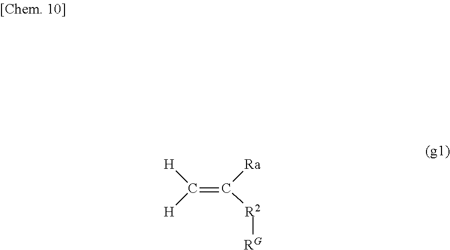

(in formula (g1), Ra represents a hydrogen atom or a methyl group, R^{G} represents the guest group, and R² is synonymous with R₁ of formula (h1)).

Among the polymerizable monomers represented by formula (g1), (meth)acrylic acid esters, derivatives thereof (i.e., R² is —COO—), (meth)acrylamide, and derivatives thereof (i.e., R¹ is —CONH— or —CONR—, and R is synonymous with the substituents described above) are preferable. In this case, the polymerization reaction easily proceeds, and the resultant macromolecular material can exhibit higher toughness and strength.

Specific examples of the guest-group-containing polymerizable monomer include n-hexyl (meth)acrylate, n-octyl (meth)acrylate, n-dodecyl (meth)acrylate, adamantyl (meth)acrylate, hydroxy adamantyl (meth)acrylate, 1-(meth)acrylamide adamantane, 2-ethyl-2-adamantyl (meth)acrylate, N-dodecyl (meth)acrylamide, t-butyl (meth)acrylate, 1-acrylamide adamantane, N-(1-adamantyl) (meth)acrylamide, N-benzyl (meth)acrylamide, N-1-naphthyl methyl (meth)acrylamide, ethoxylated o-phenyl phenol acrylate, phenoxy polyethylene glycol acrylate, isostearyl acrylate, nonyl phenol-EO adduct acrylate, and isobornyl (meth)acrylate.

The guest-group-containing polymerizable monomer can be produced by a known method. Alternatively, a commercially available product can be used as the guest-group-containing polymerizable monomer.

Examples of the type of the third polymerizable monomer for forming the third polymerizable monomer unit contained in the guest-group-containing macromolecular compound can include those of the third polymerizable monomer forming the host-group-containing macromolecular compound.

Also in the guest-group-containing macromolecular compound, as in the host-group-containing macromolecular compound described above, the third polymerizable monomer preferably has a structure in which the entirety or a part of the monomer units formed through polymerization of the third polymerizable monomer is not clathrated in the host group. The third polymerizable monomer is the same as that described above.

Specific examples of the third polymerizable monomer in the guest-group-containing macromolecular compound can include the polymerizable vinyl monomer represented by formula (a1) above. Examples of the third polymerizable monomer can include (meth)acrylic acid, allyl amine, maleic anhydride, methyl (meth)acrylate, ethyl (meth)acrylate, (meth)acrylamide, and N,N-diethyl acrylamide.

The guest-group-containing macromolecular compound includes a monomer unit based on the guest-group-containing polymerizable monomer and a monomer unit based on the third polymerizable monomer.

In the guest-group-containing macromolecular compound, the content of the guest-group-containing polymerizable monomer unit is not particularly limited. For example, the content of the guest-group-containing polymerizable monomer unit can be 0.01 to 20 mole % with respect to the total number of moles of the monomer units forming the guest-group-containing macromolecular compound. In this case, host-guest interaction easily occurs in the macromolecular material, and the mechanical strength thereof is more likely to be improved. With respect to the total number of moles of the monomer units forming the host-group-containing macromolecular compound, the content of the guest-group-containing polymerizable monomer unit is preferably 0.1 mole % or more, more preferably 0.5 mole % or more, further preferably 1 mole % or more, and particularly preferably 1.5 mole % or more. With respect to the total number of moles of the monomer units forming the guest-group-containing macromolecular compound, the content of the guest-group-containing polymerizable monomer unit is preferably 15 mole % or less, more preferably 10 mole % or less, further preferably 8 mole % or less, and particularly preferably 6 mole % or less.

When the guest-group-containing macromolecular compound is produced by polymerizing a monomer including the guest-group-containing polymerizable monomer, the polymerization method thereof is not particularly limited, and for example, a wide range of known radical polymerization methods and the like can be adopted.

The guest-group-containing macromolecular compound can be used so as to be mechanically kneaded with the host-group-containing macromolecular compound. Through this mechanical kneading, the guest-group-containing macromolecular compound and the host-group-containing macromolecular compound can undergo host-guest interaction, whereby the macromolecular material that contains the host-group-containing macromolecular compound and the guest-group-containing macromolecular compound can be obtained. The obtained macromolecular material is excellent in toughness and mechanical strength. Therefore, the guest-group-containing macromolecular compound can be suitably used for the purpose of being mechanically kneaded with the host-group-containing macromolecular compound.

The guest-group-containing macromolecular compound is not only suitable for use in mechanical kneading, but also is suitable as a raw material for forming a coat by a so-called cast method. The cast method is, for example, a method in which an applied film is formed by using a solution of a macromolecular compound and removing a volatile component (e.g., solvent) from the applied film, to form a coat. For example, a coat (macromolecular material) obtained by a cast method using a solution in which the guest-group-containing macromolecular compound and the host-group-containing macromolecular compound are dissolved can have an excellent Young's modulus, and in particular, can have a Young's modulus greater than that of a macromolecular material formed through mechanical kneading. Therefore, from the viewpoint of obtaining a macromolecular material having an excellent Young's modulus, the guest-group-containing macromolecular compound can be suitably used as a raw material for forming a coat by a cast method, and in particular, can be suitably used as a raw material for obtaining, by a cast method, a macromolecular material in which host-guest interaction is caused in combination with the host-group-containing macromolecular compound.

(Host-Group- and Guest-Group-Containing Macromolecular Compound)

The type of the host-group- and guest-group-containing macromolecular compound is not particularly limited, and, for example, a wide range of known host-group- and guest-group-containing macromolecular compounds can be adopted. Examples of the host-group- and guest-group-containing macromolecular compound can include a macromolecular compound having a host group and a guest group at a side chain. The “host-group- and guest-group-containing macromolecular compound” can mean that, for example, a host group and a guest group are chemically bonded (e.g., through covalent bond) to the main chain or side chain of the macromolecular compound. For example, the macromolecular compound has both a monomer unit in which the host group is bonded, and a monomer unit in which the guest group is bonded.

The host-group- and guest-group-containing macromolecular compound can be obtained by, for example, polymerizing (copolymerizing) a monomer including the host-group-containing polymerizable monomer and the guest-group-containing polymerizable monomer. This monomer may include the third polymerizable monomer, in addition to the host-group-containing polymerizable monomer and the guest-group-containing polymerizable monomer.

That is, the host-group- and guest-group-containing macromolecular compound can include, as structural units, the host-group-containing polymerizable monomer unit, the guest-group-containing polymerizable monomer unit, and the third polymerizable monomer unit.

Examples of the type of the host-group-containing polymerizable monomer for forming the host-group-containing polymerizable monomer unit contained in the host-group- and guest-group-containing macromolecular compound can include those of the host-group-containing polymerizable monomer in the host-group-containing macromolecular compound.

Examples of the type of the guest-group-containing polymerizable monomer for forming the guest-group-containing polymerizable monomer unit contained in the host-group- and guest-group-containing macromolecular compound can include those of the host-group-containing polymerizable monomer in the guest-group-containing macromolecular compound.

Examples of the type of the third polymerizable monomer for forming the third polymerizable monomer unit contained in the host-group- and guest-group-containing macromolecular compound can include those of the third polymerizable monomer in the host-group-containing macromolecular compound.

Also in the host-group- and guest-group-containing macromolecular compound, as in the host-group-containing macromolecular compound described above, the third polymerizable monomer preferably has a structure in which the entirety or a part of the monomer units formed through polymerization of the third polymerizable monomer is not clathrated in the host group. The third polymerizable monomer is the same as that described above.

In the host-group- and guest-group-containing macromolecular compound, the contents of the host-group-containing polymerizable monomer unit and the guest-group-containing polymerizable monomer unit are not particularly limited. For example, with respect to the total number of moles of the monomer units forming the host-group- and guest-group-containing macromolecular compound, the content of the host-group-containing polymerizable monomer unit can be 0.01 to 10 mole %, and the content of the guest-group-containing polymerizable monomer unit can be 0.01 to 10 mole %. In this case, host-guest interaction between the host-group- and guest-group-containing macromolecular compounds easily occurs in the macromolecular material, and the mechanical strength thereof is more likely to be improved. With respect to the total number of moles of the monomer units forming the host-group- and guest-group-containing macromolecular compound, the contents of the host-group-containing polymerizable monomer unit and the guest-group-containing polymerizable monomer unit are each preferably 0.05 mole % or more, more preferably 0.1 mole % or more, further preferably 0.5 mole % or more, and particularly preferably 1 mole % or more. With respect to the total number of moles of the monomer units forming the host-group- and guest-group-containing macromolecular compound, the contents of the host-group-containing polymerizable monomer unit and the guest-group-containing polymerizable monomer unit are each preferably 8 mole % or less, more preferably 6 mole % or less, further preferably 5 mole % or less, and particularly preferably 4 mole % or less.

When the host-group- and guest-group-containing macromolecular compound is produced by polymerizing a monomer including the host-group-containing polymerizable monomer and the guest-group-containing polymerizable monomer, the polymerization method thereof is not particularly limited. For example, a wide range of known radical polymerization methods and the like can be adopted.

(Macromolecular Material)

The first form of the macromolecular material contains the host-group-containing macromolecular compound and the guest-group-containing macromolecular compound. In the first form of the macromolecular material, the host-group-containing macromolecular compound preferably contains no guest group in side chains thereof. In the first form of the macromolecular material, the guest-group-containing macromolecular compound preferably contains no host group in side chains thereof.

In the first form of the macromolecular material, the content ratio between the host-group-containing macromolecular compound and the guest-group-containing macromolecular compound is not particularly limited. From the viewpoint of facilitating improvement of the mechanical strength of the macromolecular material, the content proportion between the host-group-containing macromolecular compound and the guest-group-containing macromolecular compound is preferably adjusted such that the ratio of the host group to the guest group is 1:0.01 to 1:100 in terms of molar ratio. The ratio of the host group to the guest group is more preferably 1:0.02 to 1:50, further preferably 1:0.05 to 1:20, and particularly preferably 1:0.1 to 1:10.

In the first form of the macromolecular material, host-guest interaction occurs between the host group of the host-group-containing macromolecular compound and the guest group of the guest-group-containing macromolecular compound. In this case, for example, the guest group can form a clathrate complex by being clathrated in the host group. In addition, the host group of the host-group-containing macromolecular compound and a terminal of the guest-group-containing macromolecular compound may undergo host-guest interaction. In this case, the terminal of the guest-group-containing macromolecular compound may form a clathrate complex by being clathrated in the host group, or the terminal of the guest-group-containing macromolecular compound penetrates the host group.

The second form of the macromolecular material contains the host-group- and guest-group-containing macromolecular compound described above. In the second form of the macromolecular material, host-guest interaction occurs between the host-group- and guest-group-containing macromolecular compounds. In this case, for example, the guest group can form a clathrate complex by being clathrated in the host group. In addition, the host group and a terminal of the macromolecular compound may undergo host-guest interaction. In this case, the terminal of the guest-group-containing macromolecular compound may form a clathrate complex by being clathrated in the host group, or the terminal of the guest-group-containing macromolecular compound penetrates the host group.

In the macromolecular material (including the first form and the second form) of the present invention, from the viewpoint of realizing a particularly excellent mechanical strength of the macromolecular material, when the host molecule forming the host group is α-cyclodextrin, the guest group is preferably at least one member selected from the group consisting of an n-butyl group, an n-hexyl group, an n-octyl group, and an n-dodecyl group; when the host molecule forming the host group is β-cyclodextrin, the guest group is preferably at least one member selected from the group consisting of an adamantyl group and an isobornyl group; and when the host molecule forming the host group is γ-cyclodextrin, the guest group is preferably an n-octyl group, an n-dodecyl group, a cyclododecyl group, or the like.

The macromolecular material can contain another additive or another macromolecular compound as long as the effects of the present invention are not impaired. When the macromolecular material contains an additive, the content of the additive can be 5 mass % or less, preferably 1 mass % or less, more preferably 0.1 mass % or less, and particularly preferably 0.05 mass % or less, with respect to the total mass of the macromolecular material.

The shape of the macromolecular material is not particularly limited. For example, the macromolecular material can be formed into a membrane, a film, a sheet, particles, a plate, a block, pellets, a powder, or the like.

In this macromolecular material, host-guest interaction more easily occurs than in hitherto known macromolecular materials. That is, formation ratio of the clathrate complex is higher than in hitherto known macromolecular materials, and thus, this macromolecular material has a large number of crosslinking points. This allows the macromolecular material to be excellent in toughness and mechanical strength.

In addition, the macromolecular material can have self-restorability. That is, even in such a case where a formed product of the macromolecular material has been cut, if the cut surfaces are re-contacted with each other, host-guest interaction is caused at the contact surface again, whereby the formed product of the macromolecular material can be restored. In particular, since the macromolecular material is produced by the production method described later, host-guest interaction more easily occurs in the macromolecular material than in hitherto known macromolecular materials. Accordingly, the macromolecular material more easily exhibits self-restorability than hitherto known macromolecular materials. In a case where self-restoration is to be caused, not only when the cut surfaces are contacted with each other, but also when one cut surface of the cut macromolecular material is contacted with a portion other than the other cut surface of the cut macromolecular material, host-guest interaction occurs at the contact surface, whereby cut pieces of the formed product of the macromolecular material can be joined together.

The macromolecular material can be used in various applications. For example, the macromolecular material can be suitably used for various members such as those in battery applications, automotive applications, electronic component applications, building component applications, food container applications, and transport container applications. In the battery application, the macromolecular material can be suitably used, for example, for a binder for various batteries such as lithium ion batteries.

The macromolecular material of the present invention is produced by the later-described production method of the macromolecular material. Specifically, the first form of the macromolecular material is produced by a production method A described later, and the second form of the macromolecular material is produced by a production method B described later.

2. Production Method of Macromolecular Material

According to a production method of the macromolecular material of the present invention, the macromolecular material having a structure crosslinked through host-guest interaction can be produced. The production method of the macromolecular material of the present invention includes a production method A and a production method B below.

The production method A is a method for producing the macromolecular material having a structure crosslinked through host-guest interaction. The production method A includes: step A1 of preparing a mixture that contains the host-group-containing macromolecular compound and the guest-group-containing macromolecular compound; and step A2 of mechanically kneading the mixture. Preferably, the production method A includes: step A1 of preparing a mixture that contains the host-group-containing macromolecular compound swollen or dissolved in a solvent and the guest-group-containing macromolecular compound swollen or dissolved in a solvent; and step A2 of mechanically kneading the mixture.

The production method B includes a step of mechanically kneading a raw material that contains a both host-group- and guest-group-containing macromolecular compound. Preferably, the production method B includes: step B1 of swelling or dissolving the both host-group- and guest-group-containing macromolecular compound in a solvent; and step B2 of mechanically kneading the swollen or dissolved macromolecular compound.

(Production Method A)

In the production method A, a mixture containing a host-group-containing macromolecular compound and a guest-group-containing macromolecular compound is prepared in step A1. This mixture is simply referred to as a “mixture A”. For example, the mixture A can be a mixture of the host-group-containing macromolecular compound in the form of a powder, and the guest-group-containing macromolecular compound in the form of a powder. Preferably, the host-group-containing macromolecular compound and the guest-group-containing macromolecular compound contained in the mixture A are each swollen or dissolved in a solvent.

The host-group-containing macromolecular compound used in step A1 is the same as the host-group-containing macromolecular compound described above. The guest-group-containing macromolecular compound used in step A1 is the same as the guest-group-containing macromolecular compound described above.

The host-group-containing macromolecular compound and the guest-group-containing macromolecular compound that are used in step A1 can each be in a solid state (e.g., powder).

The content ratio between the host-group-containing macromolecular compound and the guest-group-containing macromolecular compound that are used in step A1 is not particularly limited. From the viewpoint of facilitating improvement of the mechanical strength of the resultant macromolecular material, the mixing proportion between the host-group-containing macromolecular compound and the guest-group-containing macromolecular compound is preferably adjusted such that the ratio of the host group to the guest group is 1:0.01 to 1:100 in terms of molar ratio. The ratio of the host group to the guest group is more preferably 1:0.02 to 1:50, further preferably 1:0.05 to 1:20, and particularly preferably 1:0.1 to 1:10.

The type of the solvent used in step A1 is not particularly limited as long as the solvent allows the host-group-containing macromolecular compound and the guest-group-containing macromolecular compound to be swollen or dissolved therein. For example, various types of organic solvents can be used.

Examples of the organic solvent include ketone compounds such as acetone and methyl ethyl ketone; ester compounds such as ethyl acetate; ether compounds such as diethyl ether; nitrogen-containing organic compound such as N-methyl-2-pyrrolidone; alcohols such as methanol, ethanol, isopropyl alcohol, and t-butanol; aliphatic hydrocarbons such as hexane and heptane; alicyclic hydrocarbons such as cyclohexane; aromatic hydrocarbons such as benzene, toluene, and xylene; and chlorine-based hydrocarbons such as chloroform, dichloromethane, and 1,2-dichloroethane. The organic solvent can be used singly or as a mixture of two or more.

In particular, the organic solvent is preferably a ketone compound, a nitrogen-containing organic compound, an aromatic hydrocarbon, or a chlorine-based hydrocarbon since such an organic solvent allows the host-group-containing macromolecular compound and the guest-group-containing macromolecular compound to be easily swollen or dissolved therein. Particularly, the organic solvent is preferably one or more members selected from the group consisting of acetone, N-methyl-2-pyrrolidone, toluene, and dichloromethane.

The amount of the organic solvent used in step A1 is not particularly limited. For example, with respect to the total weight, i.e., 100 parts by weight, of the host-group-containing macromolecular compound and the guest-group-containing macromolecular compound, the use amount of the organic solvent can be 50 to 10000 parts by weight, preferably 80 to 5000 parts by weight, and particularly preferably 100 to 2000 parts by weight.

The method of preparing the mixture A in step A1 is not particularly limited, and any suitable method can be adopted. For example, predetermined amounts of the host-group-containing macromolecular compound and the guest-group-containing macromolecular compound are placed in a container or the like, and a predetermined amount of the organic solvent is added thereto, whereby the mixture A can be obtained.

The mixture A may contain another additive in addition to the host-group-containing macromolecular compound, the guest-group-containing macromolecular compound, and the solvent. In this case, the content proportion of the additive can be 10 mass % or less, preferably 5 mass % or less, more preferably 1 mass % or less, and particularly preferably 0.1 mass % or less, with respect to the mixture A.

After the host-group-containing macromolecular compound, the guest-group-containing macromolecular compound, and the organic solvent have been mixed together, the mixture may be allowed to stand, or may be stirred or vibrated as necessary.

The temperature and the time for the above-described swelling or dissolving operation are not particularly limited. For example, the temperature and the time may be set to be room temperature (10 to 35° C.) and 1 minute to 48 hours (preferably 5 minutes to 24 hours), respectively.

It should be noted that “the macromolecular compound is swollen in the solvent” refers to a state in which the macromolecular compound is not dissolved in the solvent and remains to an extent that the macromolecular compound can be recognized by visual observation. That “the macromolecular compound is dissolved in the solvent” refers to a state in which the macromolecular compound is not recognized in the solvent by visual observation and has become transparent, for example.

Step A2 is a step of mechanically kneading the mixture A obtained in step A1.

In step A2, the method of mechanical kneading is not particularly limited, and a wide range of known methods can be adopted. The “mechanical kneading” as used in the present specification refers to, for example, performing mixing while shearing the mixture, using various types of kneading apparatuses or grinding apparatuses.

The apparatus for performing mechanical kneading is not particularly limited, and a wide range of known apparatuses for performing kneading or grinding can be adopted. Specific examples of such an apparatus can include various kneading apparatuses such as a rotation-revolution-type kneader; various wet grinders such as a ball mill; an ultrasonic disperser; an automatic mortar; and a homogenizer.

The condition of mechanical kneading is not particularly limited, and may be the same as a known condition, for example. For example, when a rotation-revolution-type kneader is used, the condition may be “a rotation speed of 1800 rpm or higher and for 30 seconds to 10 minutes”. This kneading may be repeated twice or more.

When a planetary ball mill is used, a process may be performed, for example, using zirconia balls having a diameter of 0.1 to 3 mm, in a temperature range of −40 to 20° C. (preferably, −20 to 0° C.) for 10 seconds to 30 minutes (preferably, 30 seconds to 10 minutes). This process may be repeated twice or more.

In step A2, after the mixture has been mechanically kneaded, the volatile component such as the remaining organic solvent and the like may be dried. The drying method and the drying condition are not particularly limited.

As a result of mechanically kneading the mixture A in step A2, the macromolecular material can be obtained. In the production method A, the macromolecular material of the first form described above can be obtained.

In the mixture A, before the mixture A is subjected to step A2, host-guest interaction between the host-group-containing macromolecular compound and the guest-group-containing macromolecular compound is less likely to occur. However, when the mixture A is subjected to step A2, i.e., when the mixture A is mechanically kneaded, host-guest interaction between the host-group-containing macromolecular compound and the guest-group-containing macromolecular compound is accelerated, and the above-described macromolecular material of the present invention can be formed.

(Production Method B)

In the production method B, a raw material containing a both host-group- and guest-group-containing macromolecular compound is swollen or dissolved in a solvent in step B1. The raw material may contain another additive in addition to the both host-group- and guest-group-containing macromolecular compound. In this case, the content proportion of the additive can be 10 mass % or less, preferably 5 mass % or less, more preferably 1 mass % or less, and particularly preferably 0.1 mass % or less, with respect to the mixture A.

The both host-group- and guest-group-containing macromolecular compound used in the production method B is the same as the host-group- and guest-group-containing macromolecular compound described above.

The both host-group- and guest-group-containing macromolecular compound described above used in step B1 may be in a solid state (e.g., powder).

The type of the solvent used in step B1 is not particularly limited as long as the solvent allows the both host-group- and guest-group-containing macromolecular compound to be swollen or dissolved therein. For example, various types of organic solvents exemplified in step A1 of the production method A described above can be used.

In particular, the organic solvent used in step B1 is preferably a ketone compound, a nitrogen-containing organic compound, an aromatic hydrocarbon, or a chlorine-based hydrocarbon since such an organic solvent allows the host-group- and guest-group-containing macromolecular compound to be easily swollen or dissolved therein. Particularly, the organic solvent is preferably one or more members selected from the group consisting of acetone, N-methyl-2-pyrrolidone, toluene, and dichloromethane.

The amount of the organic solvent used in step B1 is not particularly limited. For example, with respect to the total weight, i.e., 100 parts by weight, of the host-group- and guest-group-containing macromolecular compound, the use amount of the organic solvent can be 50 to 10000 parts by weight, preferably 80 to 5000 parts by weight, and particularly preferably 100 to 2000 parts by weight.

The method of swelling the macromolecular compound in step B1 is not particularly limited, and any suitable method can be adopted. An example thereof is a method in which a predetermined amount of the both host-group- and guest-group-containing macromolecular compound is placed in a container or the like, and a predetermined amount of the organic solvent is added thereto.

After the both host-group- and guest-group-containing macromolecular compound and the organic solvent have been mixed together, the mixture may be allowed to stand, or may be stirred or vibrated as necessary.

The temperature and the time for the above-described swelling operation is not particularly limited. For example, the temperature and the time may be set to be room temperature (10 to 35° C.) and 1 minute to 48 hours (preferably 5 minutes to 24 hours), respectively.

The step B2 is a step of mechanically kneading the swollen or dissolved macromolecular compound obtained in step B1.

In step B2, the method of mechanical kneading is the same as the method of mechanical kneading performed in step A2 of the production method A described above, and can be performed under the same condition and procedure as those of step A2.

In step B2, after the swollen or dissolved macromolecular compound has been mechanically kneaded, the volatile component such as the remaining organic solvent and the like may be dried. The drying method and the drying condition are not particularly limited.

As a result of mechanically kneading the swollen macromolecular compound in step B2, the macromolecular material can be obtained. In the production method B, the macromolecular material of the second form described above can be obtained.

The macromolecular materials obtained by the production method A and the production method B have excellent mechanical strengths.

According to the production method of the present invention, even when polymerization reaction for obtaining a macromolecular compound is not performed when a macromolecular material is to be formed (that is, polymerization reaction is not performed at that site), the macromolecular material can be formed. In other words, simply by preparing a macromolecular compound obtained through polymerization reaction in advance, and using the obtained macromolecular compound in the production method A or the production method B described above, it is possible to obtain a desired macromolecular material, and there is no need to perform polymerization reaction at that site. Therefore, the production method of the present invention can be performed in a simpler manner than hitherto known production methods of a macromolecular material using host-guest interaction. Further, the production method of the present invention can also produce the macromolecular material with higher reproducibility than hitherto known production methods.

The macromolecular material is also excellent in recycling property. That is, even when the macromolecular material is used in an intended application, and then the macromolecular material is collected to be reproduced again, physical properties, particularly, mechanical strength, are less likely to be decreased, and the macromolecular material can be repeatedly used.

The reproduction method of the macromolecular material is not particularly limited. For example, when the collected macromolecular material is caused to be swollen or dissolved in a solvent by the same method as step A1 or step B1, and then, the resultant macromolecular material is mechanically kneaded by the same method as step A2 or step B2, the macromolecular material can be reproduced.

As another production method, the cast method described above can also obtain the macromolecular material. For example, the host-group-containing macromolecular compound and the guest-group-containing macromolecular compound are dissolved in a solvent to prepare a solution, and this solution is cast to a substrate or the like, whereby a coat (macromolecular material) can be formed. The type of the solvent used is not particularly limited, and a solvent that allows both the host-group-containing macromolecular compound and the guest-group-containing macromolecular compound to be dissolved therein, can be used. The concentration of the solution is not particularly limited as long as a cast film can be formed. The coat (macromolecular material) obtained in this manner can have an excellent Young's modulus, in particular, a Young's modulus greater than that of a macromolecular material formed through mechanical kneading.

3. Macromolecular Composition

The macromolecular composition of the present invention contains the host-group-containing macromolecular compound swollen or dissolved in the solvent and the guest-group-containing macromolecular compound swollen or dissolved in the solvent. That is, the macromolecular composition of the present invention is the mixture A prepared in step A1 above.

In the macromolecular composition, host-guest interaction between the host-group-containing macromolecular compound and the guest-group-containing macromolecular compound is less likely to occur. However, for example, when the composition is subjected to step A2 above, i.e., when the composition is mechanically kneaded, host-guest interaction between the host-group-containing macromolecular compound and the guest-group-containing macromolecular compound is accelerated, and the above-described macromolecular material of the present invention can be formed. Therefore, the macromolecular composition is suitable as a raw material for producing the macromolecular material.

### EXAMPLES

In the following, the present invention is more specifically described by way of Examples. However, the present invention is not limited to the aspects of these Examples.

### Synthesis Example 1-1; Production of Host-Group-Containing Polymerizable Monomer

5 g (3.9 mmol) of β-cyclodextrin, 700 mg (6.9 mmol) of N-hydroxymethyl acrylamide, and 95 mg (0.6 mmol) of p-toluenesulfonic acid monohydrate were weighed and placed in a 200-mL round-bottom glass flask, and the mixture was added to 25 mL of N,N-dimethylformamide, whereby a reaction liquid was prepared. This reaction liquid was heated to 90° C. in an oil bath, and then stirred for 1 hour while being heated. Subsequently, the resultant reaction liquid was cooled and poured into 45 mL of strongly stirred acetone. Formed precipitate was filtered off, washed with 10 mL of acetone three times, and then dried at room temperature under reduced pressure for 1 hour, whereby a reaction product was obtained. The reaction product was dissolved in 100 mL of distilled water, and passed through a column packed with a porous polystyrene resin (Mitsubishi Chemical Corporation DIAION HP-20) (apparent density: 600 g/L), to allow for adsorption for 30 minutes. In some cases, instead of using this column, preparative high-pressure liquid chromatography was used to perform separation and purification. Thereafter, the solution component was removed, and 50 mL of a 10% methanol (or acetonitrile) aqueous solution was newly passed through the column three times to wash the polystyrene resin, whereby unreacted β-cyclodextrin was removed. Subsequently, 500 mL of a 25% methanol aqueous solution was passed through the column twice to elute acrylamide methyl β-cyclodextrin (hereinafter, referred to as “βCDAAmMe”), which was the target product. The solvent was removed under reduced pressure, whereby 809 mg of a white powder compound represented by formula (7-2) was obtained. The yield was about 15%.

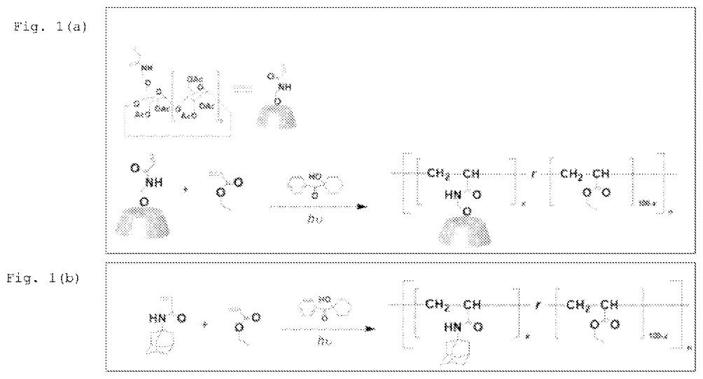

Next, 20 g of βCDAAmMe was dissolved in 300 mL of pyridine, and 170.133 g of acetic anhydride was added thereto, followed by stirring at 55° C. for 12 hours or more. Thereafter, 50 mL of methanol was added thereto for quenching, and the content was concentrated to a volume of 200 mL with an evaporator. The obtained concentrated solution was added dropwise to 2000 mL of water, and the precipitate was collected. The precipitate was dissolved in 200 mL of acetone, the resultant solution was added dropwise to 2000 mL of water, and formed precipitate was collected. This precipitate was dried under reduced pressure, to isolate N—H-TAcβAAmMe (see FIG. 1), which was the target product. From the results of the mass spectrum and NMR spectrum, formation of the target compound (N—H-TAcβAAmMe) was confirmed. 100% of the total number of hydroxy groups present per molecule of the cyclodextrin derivative in N—H-TAcβAAmMe were confirmed to have been substituted with acetyl groups, and N—H-TAcβAAmMe was confirmed to be a host-group-containing polymerizable monomer represented by formula (h1-8) described above.

### Synthesis Example 2-1; Production of Host-Group-Containing Macromolecular Compound

Polymerization reaction was performed according to the synthesis scheme shown in FIG. 1(a). A polymerizable monomer mixture in which 0.5297 g of N—H-TAcβAAmMe, which was the host-group-containing polymerizable monomer obtained in Synthesis Example 1-1, and 0.00528 g of “IRGACURE 184 (registered trademark)” as a photopolymerization initiator were dissolved in 2.553 g of ethyl acrylate, was prepared. In the polymerizable monomer mixture, the content of the host-group-containing polymerizable monomer was 1 mole % with respect to the total number of moles of the polymerizable monomer. Ultraviolet light (λ=365 nm) was applied to the polymerizable monomer mixture for 30 minutes, whereby bulk polymerization was performed. The obtained polymer was dried in a 60° C. atmosphere for 23 hours, whereby a host-group-containing macromolecular compound was obtained. The obtained host-group-containing macromolecular compound is referred to as “host polymer H1”.

### Synthesis Example 2-2; Production of Host-Group-Containing Macromolecular Compound

A host-group-containing macromolecular compound was obtained by the same method as that in Synthesis Example 2-1, except that the amount of N—H-TAcβAAmMe, which was the host-group-containing polymerizable monomer obtained in Synthesis Example 1-1, was changed to 1.0043 g, the amount of the photopolymerization initiator was changed to 0.00501 g, and the amount of ethyl acrylate was changed to 2.3866 g. In the polymerizable monomer mixture, the content of the host-group-containing polymerizable monomer was 2 mole % with respect to the total number of moles of the polymerizable monomer. The obtained host-group-containing macromolecular compound is referred to as “host polymer H2”.

### Synthesis Example 2-3; Production of Host-Group-Containing Macromolecular Compound

A host-group-containing macromolecular compound was obtained by the same method as that in Synthesis Example 2-1, except that the amount of N—H-TAcβAAmMe, which was the host-group-containing polymerizable monomer obtained in Synthesis Example 1-1, was changed to 1.5861 g, the amount of the photopolymerization initiator was changed to 0.00528 g, and the amount of ethyl acrylate was changed to 2.5038 g. In the polymerizable monomer mixture, the content of the host-group-containing polymerizable monomer was 3 mole % with respect to the total number of moles of the polymerizable monomer. The obtained host-group-containing macromolecular compound is referred to as “host polymer H3”.

### Synthesis Example 3-1; Production of Guest-Group-Containing Macromolecular Compound

Polymerization reaction was performed according to the synthesis scheme shown in FIG. 1(b). A polymerizable monomer mixture in which 0.4768 of adamantyl acrylamide and 0.0475 g of “IRGACURE 184 (registered trademark)” as a photopolymerization initiator were dissolved in 23.0002 g of ethyl acrylate, was prepared. In the polymerizable monomer mixture, the content of the guest-group-containing polymerizable monomer was 1 mole % with respect to the total number of moles of the polymerizable monomer. Ultraviolet light (λ=365 nm) was applied to the polymerizable monomer mixture for 30 minutes, whereby bulk polymerization was performed. The obtained polymer was dried in a 60° C. atmosphere for 16 hours, whereby a host-group-containing macromolecular compound was obtained. The obtained host-group-containing macromolecular compound is referred to as “guest polymer G1”.

### Synthesis Example 3-2; Production of Guest-Group-Containing Macromolecular Compound

A guest-group-containing macromolecular compound was obtained by the same method as that in Synthesis Example 3-1, except that the amount of adamantyl acrylamide was changed to 0.6275 g, the amount of the photopolymerization initiator was changed to 0.0312 g, and the amount of ethyl acrylate was changed to 15.0004 g. In the polymerizable monomer mixture, the content of the guest-group-containing polymerizable monomer was 2 mole % with respect to the total number of moles of the polymerizable monomer. The obtained guest-group-containing macromolecular compound is referred to as “host polymer G2”.

### Synthesis Example 3-3; Production of Guest-Group-Containing Macromolecular Compound

A guest-group-containing macromolecular compound was obtained by the same method as that in Synthesis Example 3-1, except that the amount of adamantyl acrylamide was changed to 0.3019 g, the amount of the photopolymerization initiator was changed to 0.0100 g, and the amount of ethyl acrylate was changed to 4.7572 g. In the polymerizable monomer mixture, the content of the guest-group-containing polymerizable monomer was 3 mole % with respect to the total number of moles of the polymerizable monomer. The obtained guest-group-containing macromolecular compound is referred to as “host polymer G3”.

### Synthesis Example 4-1; Production of Host-Group- and Guest-Group-Containing Macromolecular Compound

A polymerizable monomer mixture composed of 0.5 mole % of N—H-TAcβAAmMe obtained in Synthesis Example 1-1, 0.5 mole % of adamantyl acrylamide, and 99 mole % of ethyl acrylate was prepared. This polymerizable monomer mixture was subjected to ultrasonication for 1 hour, then, 0.1 mole %, with respect to the monomer, of “IRGACURE 184 (registered trademark)” as a polymerization initiator was added thereto, and ultraviolet light (λ=365 nm) was applied to the mixture for 30 minutes, whereby polymerization reaction was performed. Then, the resultant mixture was dried in a 100° C. atmosphere for 12 hours, whereby a host-group- and guest-group-containing macromolecular compound was obtained. The obtained host-group- and guest-group-containing macromolecular compound is referred to as “host-guest polymer HG1”.

### Synthesis Example 4-2; Production of Host-Group- and Guest-Group-Containing Macromolecular Compound

A host-group- and guest-group-containing macromolecular compound was obtained by the same method as that in Synthesis Example 4-1, except that the polymerizable monomer mixture was changed to a polymerizable monomer mixture composed of 1 mole % of N—H-TAcβAAmMe obtained in Synthesis Example 1-1, 1 mole % of adamantyl acrylamide, and 98 mole % of ethyl acrylate. The obtained host-group- and guest-group-containing macromolecular compound is referred to as “host-guest polymer HG2”.

### Synthesis Example 4-3; Production of Host-Group- and Guest-Group-Containing Macromolecular Compound

A host-group- and guest-group-containing macromolecular compound was obtained by the same method as that in Synthesis Example 4-1, except that the polymerizable monomer mixture was changed to a polymerizable monomer mixture composed of 1.5 mole % of N—H-TAcβAAmMe obtained in Synthesis Example 1-1, 1.5 mole % of adamantyl acrylamide, and 97 mole % of ethyl acrylate. The obtained host-group- and guest-group-containing macromolecular compound is referred to as “host-guest polymer HG3”.

### Example 1-1

### Example 1-1-1

308.3 mg of host polymer H1 obtained in Synthesis Example 2-1 and 261.2 mg of guest polymer G1 obtained in Synthesis Example 3-1 were mixed together, and an amount of acetone (1708 μL), which was 1.2 times the total polymer weight (the total weight of host polymer H1 and guest polymer G1), was added thereto. The resultant mixture was held for 30 minutes, to allow the mixture of host polymer H1 and guest polymer G1 to swell. The contents of the host group and the guest group were each set to be 1 mole % with respect to the entire polymer.

Then, the swollen polymer was mechanically kneaded using a rotation-revolution-type kneader (“Awatori Rentaro (THINKY MIXER) ARE-310 (registered trademark)” manufactured by THINKY CORPORATION). The kneading condition of this apparatus was set such that: the number of revolutions was 2000 rpm; and 1 cycle of kneading time was 5 minutes. When the state of the kneaded polymer was visually observed, and if lumps or the like were observed, 2 or more cycles of kneading were performed as necessary. When 2 or more cycles were performed, acetone was further added as appropriate. In this Example, the number of cycles was 8 and 854 μL of acetone was further added.

The thus obtained viscous fluid was vacuum dried at 30° C. for 10 hours and then held in a 100° C. atmosphere for 12 hours, whereby a target macromolecular material was obtained.

### Example 1-1-2

A viscous fluid was obtained by the same method as that in Example 1-1-1, except that, 309.6 mg of host polymer H2 obtained in Synthesis Example 2-2 was used instead of host polymer H1, 228.9 mg of guest polymer G2 obtained in Synthesis Example 3-2 was used instead of guest polymer G1, and the amount of acetone in the first cycle of kneading was changed to 1616 μL. The contents of the host group and the guest group were each set to be 2 mole % with respect to the entire polymer. In this Example, the number of cycles was 16 and 1290 μL of acetone was further added. The obtained viscous fluid was vacuum dried at 30° C. for 13 hours and then held in a 100° C. atmosphere for 12 hours, whereby a target macromolecular material was obtained.

### Example 1-1-3

A viscous fluid was obtained by the same method as that in Example 1-1-1, except that 309.6 mg of host polymer H3 obtained in Synthesis Example 2-3 was used instead of host polymer H1, 228.9 mg of guest polymer G3 obtained in Synthesis Example 3-3 was used instead of guest polymer G1, and the amount of acetone in the first cycle of kneading was changed to 1616 μL. The contents of the host group and the guest group were each set to be 3 mole % with respect to the entire polymer. In this Example, the number of cycles was 16 and 1290 μL of acetone was further added. The obtained viscous fluid was vacuum dried at 30° C. for 8 hours and then held in a 100° C. atmosphere for 12 hours, whereby a target macromolecular material was obtained.

### Example 1-2

### Example 1-2-1

310.4 mg of host polymer H1 obtained in Synthesis Example 2-1 and 262.3 mg of guest polymer G1 obtained in Synthesis Example 3-1 were mixed together, and an amount of N-methyl-2-pyrrolidone (10110 μL), which was 18 times the total polymer weight (the total weight of host polymer H1 and guest polymer G1), was added thereto. The resultant mixture was held for 24 hours, to allow the mixture of host polymer H1 and guest polymer G1 to swell. The contents of the host group and the guest group were each set to be 1 mole % with respect to the entire polymer.

Then, zirconia balls (diameter 3 mm) having 25 times the total weight of the swollen polymer was added to the swollen polymer, and the resultant mixture was held at −20° C., and then, subjected to grinding using a planetary ball mill (“Funsai Nano Taro (Nano Pulverizer) NP-100” (registered trademark) manufactured by THINKY corporation). The grinding condition of this apparatus was set such that: the number of revolutions was 2000 rpm; and the grinding time was 1 minute. Then, a viscous fluid obtained through filtration was cast in a Teflon (registered trademark) dish to form a film, and the film was held in a 100° C. atmosphere for 12 hours, whereby a target macromolecular material was obtained.

### Example 1-2-2

A target macromolecular material was obtained by the same method as that in Example 1-2-1, except that 303.1 mg of host polymer H2 obtained in Synthesis Example 2-2 was used instead of host polymer H1, 223.7 mg of guest polymer G2 obtained in Synthesis Example 3-2 was used instead of guest polymer G1, and the amount of N-methyl-2-pyrrolidone was changed to 9296 μL. The contents of the host group and the guest group were each set to be 2 mole % with respect to the entire polymer.

### Example 1-2-3

A target macromolecular material was obtained by the same method as that in Example 1-2-1, except that 369.3 mg of host polymer H3 obtained in Synthesis Example 2-3 was used instead of host polymer H1, 240 mg of guest polymer G3 obtained in Synthesis Example 3-3 was used instead of guest polymer G1, and the amount of N-methyl-2-pyrrolidone was changed to 10750 μL. The contents of the host group and the guest group were each set to be 3 mole % with respect to the entire polymer.

### Example 2-1

### Example 2-1-1

A macromolecular material was obtained by the same method as that in Example 1-1-1, except that host-guest polymer HG1 obtained in Synthesis Example 4-1 was singly used instead of host polymer H1 and host polymer G1.

### Example 2-1-2

A macromolecular material was obtained by the same method as that in Example 1-1-2, except that host-guest polymer HG2 obtained in Synthesis Example 4-2 was singly used instead of host polymer H2 and host polymer G2.

### Example 2-1-3

A macromolecular material was obtained by the same method as that in Example 1-1-3, except that host-guest polymer HG3 obtained in Synthesis Example 4-3 was singly used instead of host polymer H3 and host polymer G3.

### Example 2-2

### Example 2-2-1

A macromolecular material was obtained by the same method as that in Example 1-2-1, except that host-guest polymer HG1 obtained in Synthesis Example 4-1 was singly used instead of host polymer H1 and host polymer G1.

### Example 2-2-2

A macromolecular material was obtained by the same method as that in Example 1-2-2, except that host-guest polymer HG2 obtained in Synthesis Example 4-2 was singly used instead of host polymer H2 and host polymer G2.

### Example 2-2-3

A macromolecular material was obtained by the same method as that in Example 1-2-3, except that host-guest polymer HG3 obtained in Synthesis Example 4-3 was singly used instead of host polymer H3 and host polymer G3.

### Reference Example 1

### Reference Example 1-1

306.3 mg of host polymer H1 obtained in Synthesis Example 2-1 and 260.8 mg of guest polymer G1 obtained in Synthesis Example 3-1 were mixed together, and 71.5 mL of acetone was added with respect to the total polymer weight (the total weight of host polymer H1 and guest polymer G1) (such that the polymer concentration became 1 weight %), to prepare a solution. This solution was cast in a Teflon (registered trademark) dish to form a film, and the film was held in a 100° C. atmosphere for 12 hours, whereby a macromolecular material was obtained.

### Reference Example 1-2

A macromolecular material was obtained by the same method as that in Reference Example 1-1, except that host polymer H1 was changed to host polymer H2 obtained in Synthesis Example 2-2 and guest polymer G1 was changed to guest polymer G2 obtained in Synthesis Example 3-2.

### Reference Example 1-3

A macromolecular material was obtained by the same method as that in Reference Example 1-1, except that host polymer H1 was changed to host polymer H3 obtained in Synthesis Example 2-3 and guest polymer H3 was changed to guest polymer G3 obtained in Synthesis Example 3-3.

### Comparative Example 2

### Comparative Example 2-1

A tensile test described later was performed using host-guest polymer HG1 obtained in Synthesis Example 4-1.

### Comparative Example 2-2

A tensile test described later was performed using host-guest polymer HG2 obtained in Synthesis Example 4-2.

### Comparative Example 2-3

A tensile test described later was performed using host-guest polymer HG3 obtained in Synthesis Example 4-3.

<Evaluation Method>

(Tensile Test)

### (1) Preparation of Test Piece for Tensile Test (Press Molding and Punching)

A 0.1 mm Teflon (registered trademark) sheet was fixed on a flat aluminum plate having a thickness of 0.4 mm, and a macromolecular material was placed on the sheet. A spacer having a thickness of 0.2 mm (mold of 4 cm×4 cm) was disposed around the macromolecular material. A 0.4 mm aluminum plate also having a 0.1 mm Teflon (registered trademark) sheet thereon was placed on the macromolecular material such that the Teflon (registered trademark) surface contacts the macromolecular material, to form a laminate.

Then, the laminate was pressed under force of 2 kN for 4 minutes using a 100° C. vacuum heat-pressing machine, to obtain a film. The film was allowed to stand at room temperature (25° C.) for 15 hours, and then, the film was punched into a dumbbell shape by a THOMSON blade, to obtain a test piece (target thickness was 0.2 mm).

### (2) Tensile Test

As the tensile test, a “stroke-test force curve” test was performed using “AUTOGRAPH” (manufactured by Shimadzu Corporation (model number: AGX-plus)) at room temperature and at a pulling speed of 5 mm/s (uniaxial elongation until occurrence of breaking. Change in stress was recorded), and the breaking point of the test piece was observed. Using this breaking point as an end point, the maximum stress up to the end point was defined as the breaking stress of the macromolecular material. This tensile test was performed with the lower end of the macromolecular material fixed and the upper end of the macromolecular material pulled upward at a pulling speed of 5 mm/second. A value obtained by dividing the stroke at that time, i.e., the maximum length at the time of pulling the test piece, by the length of the test piece before being pulled was calculated as a stretch rate (which may be referred to as “strain rate”).

In the “stroke-test force curve” (stress-strain curve) test, when a material exhibits a high value in either one or both of breaking stress and breaking strain (also simply referred to as “strain”), the macromolecular material can be determined to be excellent in toughness and strength. In particular, when the material exhibits a high value in both of breaking stress and strain, the material can be determined to be excellent in fracture energy.

<Test Result>

In the following, “Example 1-1” means Example 1-1-1, Example 1-1-2, and Example 1-1-3. Similarly, “Example 1-2” means Example 1-2-1, Example 1-2-2, and Example 1-2-3; “Example 2-1” means Example 2-1-1, Example 2-1-2, and Example 2-1-3; “Example 2-2” means Example 2-2-1, Example 2-2-2, and Example 2-2-3; “Reference Example 1” means Reference Example 1-1, Reference Example 1-2, and Reference Example 1-3; and “Comparative Example 2” means Comparative Example 2-1, Comparative Example 2-2, and Comparative Example 2-3.

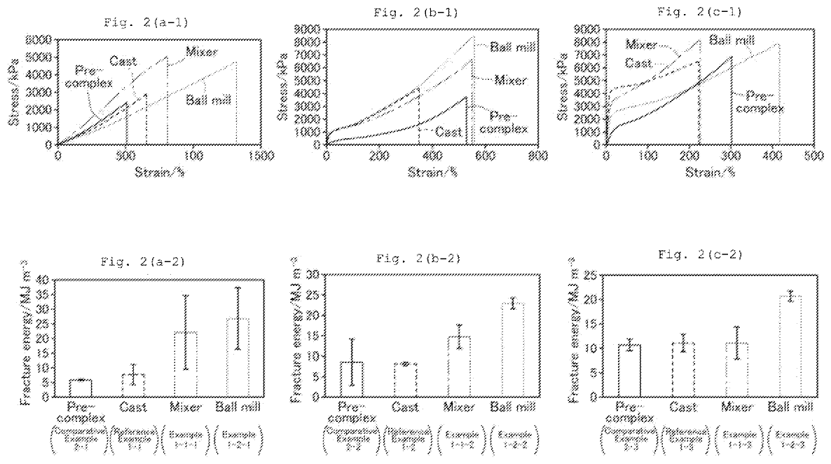

FIG. 2 shows results of tensile tests performed on the macromolecular materials obtained in Example 1-1, Example 1-2, Reference Example 1, and Comparative Example 2. (a-1), (b-1), and (c-1) each show stress-strain curves, and (a-2), (b-2), and (c-2) each show a graph of calculation results of fracture energy calculated from the areas of the respective stress-strain curves.

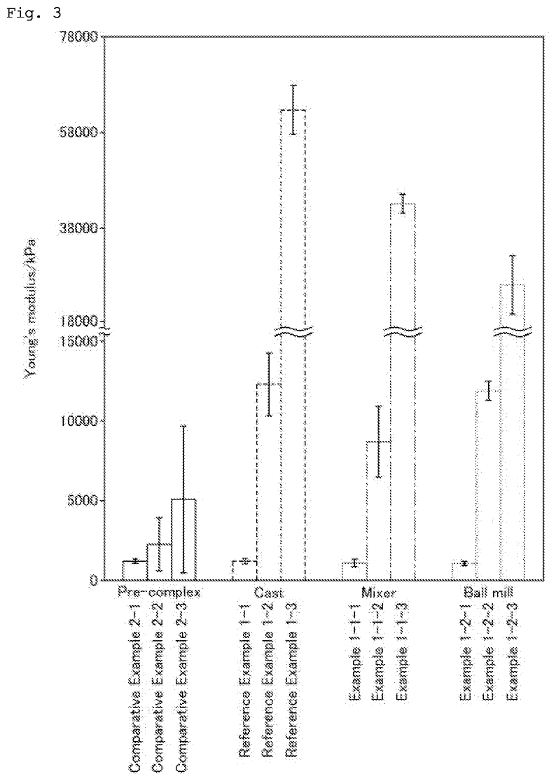

FIG. 3 shows Young's modulus calculated from each of the stress-strain curves obtained in the tensile tests performed on the macromolecular materials obtained in Example 1-1, Example 1-2, Reference Example 1, and Comparative Example 2. The Young's modulus was calculated from the slope of a line segment connecting a stress at 0.5% and a stress at 5.5% in the stress-strain curve.

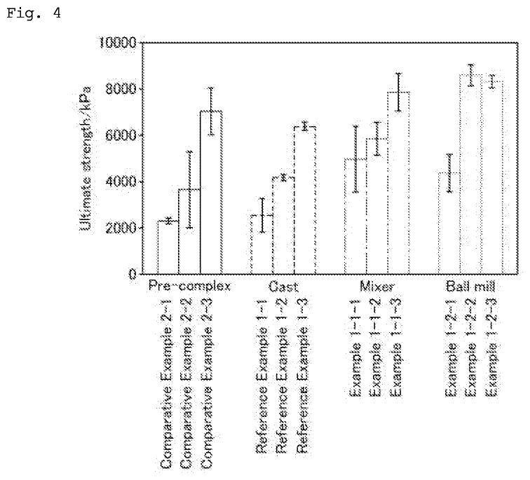

FIG. 4 shows the maximum stress calculated from each of the stress-strain curves obtained in the tensile tests performed on the macromolecular materials obtained in Example 1-1, Example 1-2, Reference Example 1, and Comparative Example 2. The maximum stress was obtained from the highest point of the stress-strain curve.

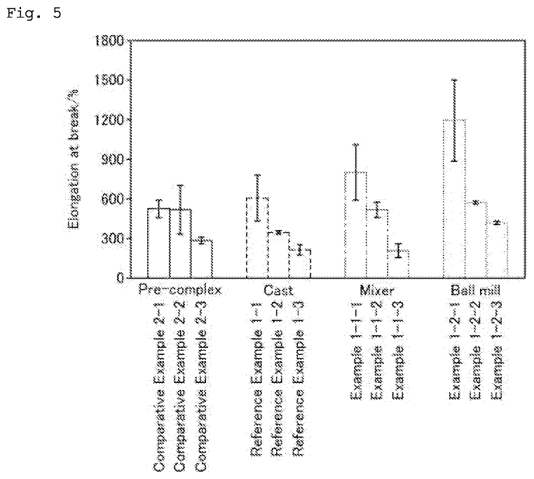

FIG. 5 shows elongation at break calculated from each of the stress-strain curves obtained in the tensile tests performed on the macromolecular materials obtained in Example 1-1, Example 1-2, Reference Example 1, and Comparative Example 2. The elongation at break was obtained from a sudden drop point in the stress-strain curve.

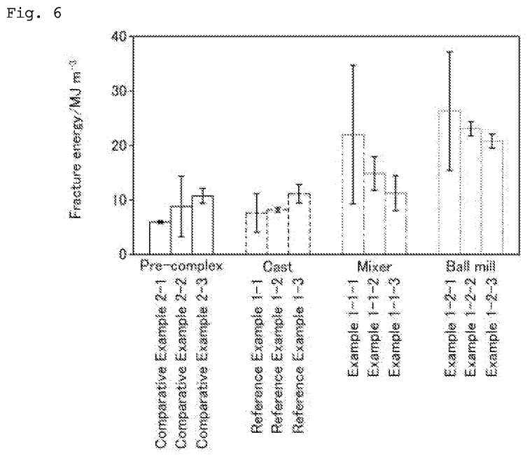

FIG. 6 shows fracture energy calculated from each of the stress-strain curves obtained in the tensile tests performed on the macromolecular materials obtained in Example 1-1, Example 1-2, Reference Example 1, and Comparative Example 2.

From FIGS. 2 to 6, when macromolecular materials that have the same content proportion of the host group (or the guest group) are compared with each other, the macromolecular materials obtained in Examples 1-1, 1-2 can be determined to be excellent in toughness and strength when compared with the macromolecular materials obtained in Reference Example 1 and Comparative Example 2, and were found to have excellent fracture energy. This result shows that the macromolecular materials obtained in Examples 1-1, 1-2 have excellent mechanical strength. Further, with reference to FIG. 3, the macromolecular materials obtained in Examples 1-1, 1-2 and Reference Example 1 had higher Young's modulus than the macromolecular materials obtained in Comparative Example 2. In particular, the macromolecular materials obtained in Reference Example 1 had higher Young's modulus than the macromolecular materials, which were mechanically kneaded, obtained in Examples 1-1, 1-2.

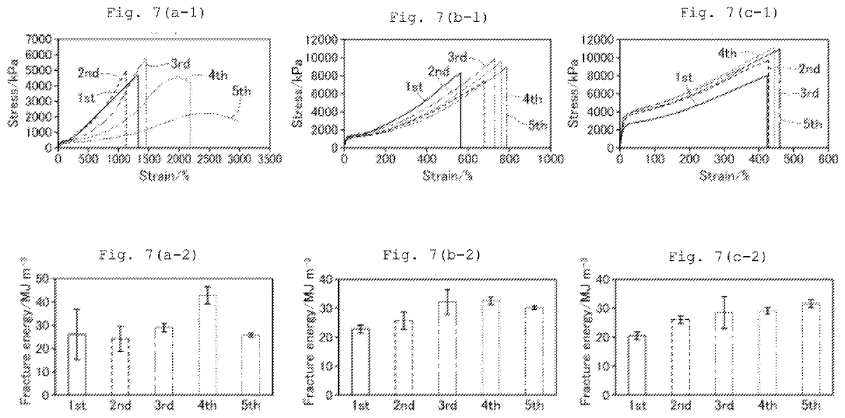

FIG. 7 shows results of recycling property of the macromolecular materials obtained in Example 1-2. With respect to the recycling property, the macromolecular materials having been subjected to the tensile test were collected, then the macromolecular materials were reproduced by the same method as that in Example 1-2, and the tensile test was performed using the reproduced macromolecular materials. In FIG. 7, “1st” is the initial tensile test result obtained in Example 1-2, (i.e., the sample not having been subjected to the tensile test); “2nd” is a measurement result of the sample reproduced after the first tensile test; “3rd” is a measurement result of the sample reproduced after the second tensile test; “4th” is a measurement result of the sample reproduced after the third tensile test; and “5th” is a measurement result of the sample reproduced after the fourth tensile test.

With reference to FIG. 7, the macromolecular materials obtained in Example 1-2 were found to maintain excellent mechanical strength after repeated use, and were excellent in the recycling property.

(Self-Restorability)

When self-restorability of the macromolecular materials obtained in Examples 1-1, 1-2 was confirmed, each of the macromolecular materials was confirmed to have self-restorability. The self-restorability was evaluated by the following procedure. The macromolecular material was cut with a razor, and the cut surfaces were put together, to be allowed to stand in an 80° C. atmosphere for 2 hours. The resultant sample was cooled to room temperature, and both ends of the sample were pulled with tweezers, to confirm the self-restorability.

(Battery Binder Evaluation)

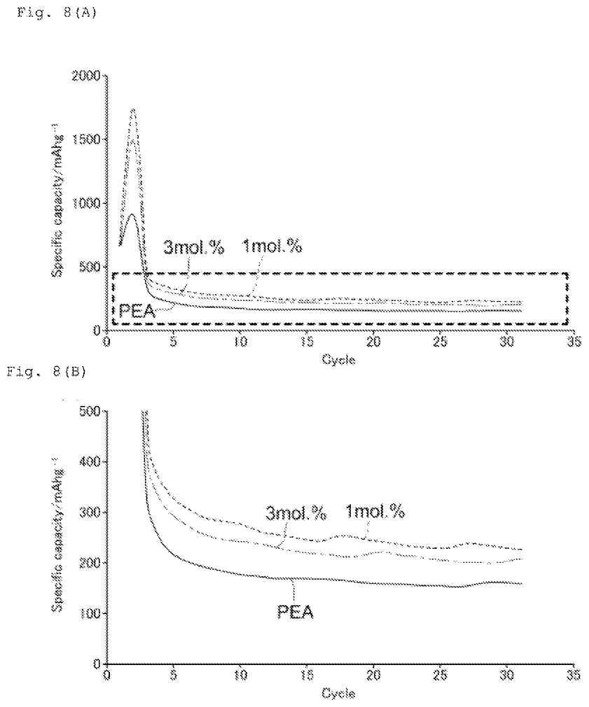

FIG. 8 shows results of charging and discharging of batteries in which the macromolecular materials obtained in Example 2-1 were used as binders (FIG. 8(B) is a partially enlarged view of FIG. 8(A)). For comparison, FIG. 8 also shows a result of evaluation of a case where polyethyl acrylate (PEA) was used as a binder. This evaluation was performed as follows.

A macromolecular material, active carbon, and acetylene black (DENKA Black Li-400 (registered trademark)) were kneaded in N-methyl-2-pyrrolidone until the mixture became uniform, to prepare a sample liquid. This sample liquid was applied to a 20 μm-thick copper foil using a 75 μm blade, and then dried in a 100° C. atmosphere for 2 hours. Then, the resultant matter was punched so as to have a diameter of 11 mm. This sample was placed in a glove box filled with argon. Thereafter, a half cell using Li metal was assembled, using 1.0 M LIPF₆ EC/DEC=1/1 (v/v %) (manufactured by Aldrich) as an electrolytic solution (LiPF₆ in Ethyl carbonate (EC)/Diethyl carbonate (DEC) 1/1 (v/v)), and Celgard #2400 (registered trademark) as a separator. This half cell was allowed to stand in an argon atmosphere for 12 hours or more, and then, a charge-discharge experiment was performed. The measurement in the charge-discharge test was performed, with the pre-cycle performed once at 0.05C, the main cycle performed 30 times at 0.5C, and the voltage range set at 0.02 V to 1.5 V.

From the results shown in FIG. 8, the macromolecular materials obtained in Example 2-1 were found to have excellent cycle property also when compared with PEA.

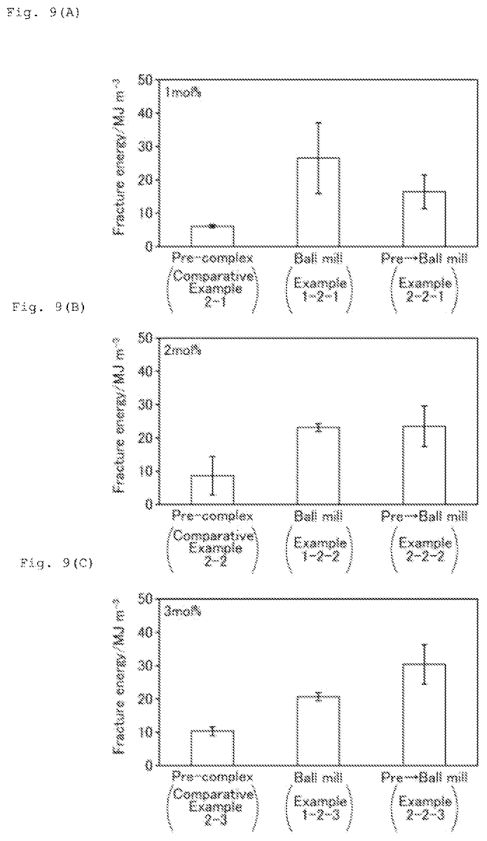

FIG. 9 shows graphs of calculation results of fracture energy of the macromolecular materials obtained in Example 1-2, Example 2-2, and Comparative Example 2 (calculated by the same method as that in the test in FIG. 2).

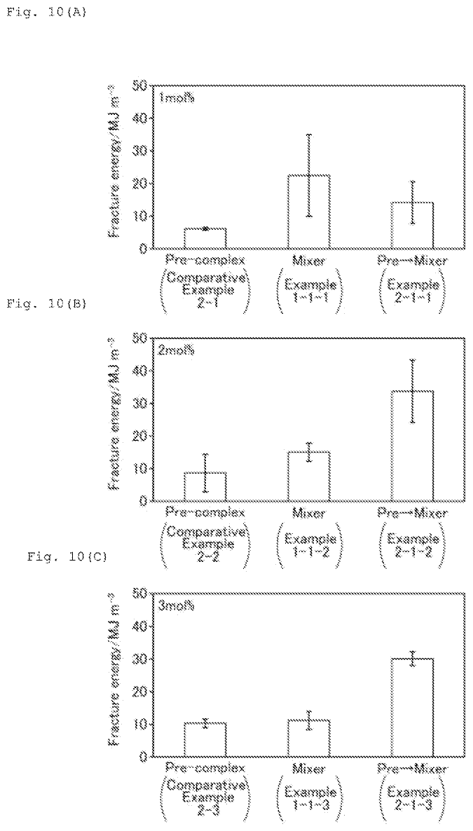

FIG. 10 shows graphs of calculation results of fracture energy of the macromolecular materials obtained in Example 1-1, Example 2-1, and Comparative Example 2 (calculated by the same method as that in the test in FIG. 2).

FIGS. 9 and 10 revealed that the macromolecular materials obtained in Example 2-1 also have excellent fracture energy.

1. A macromolecular material having a structure crosslinked through host-guest interaction, the macromolecular material being obtained by a method comprising:
a step of preparing a mixture that contains a host-group-containing macromolecular compound and a guest-group-containing macromolecular compound; and
a step of mechanically kneading the mixture.

2. The macromolecular material according to claim 1, wherein the host-group-containing macromolecular compound and the guest-group-containing macromolecular compound contained in the mixture are each swollen or dissolved in a solvent.

3. A macromolecular material having a structure crosslinked through host-guest interaction, the macromolecular material being obtained by a method comprising
a step of mechanically kneading a raw material that contains a both host-group- and guest-group-containing macromolecular compound.

4. The macromolecular material according to claim 3, wherein the both host-group- and guest-group-containing macromolecular compound contained in the raw material is swollen or dissolved in a solvent.

5. A production method of the macromolecular material of claim 1 having a structure crosslinked through host-guest interaction, the production method comprising:
a step of preparing the mixture that contains the host-group-containing macromolecular compound and the guest-group-containing macromolecular compound; and
a step of mechanically kneading the mixture.

6. The production method according to claim 5, wherein the host-group-containing macromolecular compound and the guest-group-containing macromolecular compound contained in the mixture are each swollen or dissolved in a solvent.

7. A production method of the macromolecular material of claim 3 having a structure crosslinked through host-guest interaction, the production method comprising
a step of mechanically kneading the raw material that contains a both the host-group- and the guest-group-containing macromolecular compound.

8. The production method according to claim 7, wherein the both host-group- and guest-group-containing macromolecular compound contained in the raw material is swollen or dissolved in a solvent.

9. A macromolecular composition that contains a host-group-containing macromolecular compound swollen or dissolved in a solvent and a guest-group-containing macromolecular compound swollen or dissolved in a solvent.

10. The macromolecular composition according to claim 9, wherein the solvent includes an organic solvent.

11. The host-group-containing macromolecular compound of claim 1 configured to be used so as to be mechanically kneaded with the guest-group-containing macromolecular compound,
the host-group-containing macromolecular compound being configured to undergo host-guest interaction with the guest-group-containing macromolecular compound.

12. The guest-group-containing macromolecular compound of claim 1 configured to be used so as to be mechanically kneaded with the host-group-containing macromolecular compound,
the guest-group-containing macromolecular compound being configured to undergo host-guest interaction with the host-group-containing macromolecular compound.
